(19) United States
(12) Patent Application Publication
(10) Pub. No.: US 2020/0265468 A1
(43) Pub. Date: Aug. 20, 2020

(54) SELF-PROFILING METHOD AND SYSTEM FOR USE OF SECURITY PROGRAMS OR OPERATING SYSTEMS IN DIGITAL MARKETING

(71) Applicant: Dejan Petkov, Belgrade (RS)

(72) Inventor: Dejan Petkov, Belgrade (RS)

(21) Appl. No.: 16/802,575

(22) Filed: Feb. 27, 2020

(30) Foreign Application Priority Data
Jul. 17, 2018 (RS) P-2018/0815

(51) Int. Cl. G06Q 30/02

(52) U.S. Cl. CPC G06Q 30/0248; G06Q 30/0269

(57) ABSTRACT

The self-profiling method and system for use of security programs based on antivirus protection or operating system for digital marketing allows direct access and direct advertising delivery to the user's personal computer or the smart portable device through the security program or operating system. Using security program or operating system, which regularly intercepts data on the user device, a special Agent Module performs analysis of user actions and interests and creates a Dynamic user profile in the process named Self-profiling. Comparing the local Dynamic User profile against Desired profile proposed by Advertiser the Agent Module selects and downloads the promotional content. Finally, Agent Module displays selected advertising content either independently, either through another applications or by inserting advertisement into regularly downloaded web content which is then presented to the user in web browser.

### FIELD OF CLASSIFICATION SEARCH

Generally, the invention belongs to the field of digital marketing, or more precisely—advertising and marketing analysis of digital user data.

According to USPC the invention belongs to the following classification:

705—DATA PROCESSING: FINANCIAL, BUSINESS PRACTICE, MANAGEMENT, OR COST/PRICE DETERMINATION

705/14.4—Advertisement

705/14.49—Targeted advertisement

705/14.53—Based on user history

705/14.58—Advertisement based on user location

705/14.66—Advertisement based on user profile or attribute

705/14.67—Personalized advertisement

705/14.71—Auction

705/17.73—Online advertisement

According to the International Patent Classification the invention is mostly related to the following classifications:

G06—COMPUTING; CALCULATING; COUNTING

G06Q 30/02—Marketing, e.g. market research and analysis, surveying, promotions, advertising, customer profiling, customer management or rewards; Price estimation or determination

G06Q 30/0241—Advertisement

G06Q 30/0251—Targeted advertisement

G06Q 30/0263—based upon Internet or website rating

G06Q 30/0271—Personalized advertisement

G06Q 30/0277—Online advertisement

G06Q 30/0617—Anonymizing

G06Q 90/00—Systems or methods specially adapted for administrative, commercial, financial, managerial, supervisory or forecasting purposes, not involving significant data processing

G09F—DISPLAYING; ADVERTISING; SIGNS; LABELS OR NAME-PLATES; SEALS

### BACKGROUND OF THE INVENTION

In modern digital marketing, user data analysis, user profiling and targeting are done remotely, processing large amount of data collected from a large number of users. Data is often collected, exchanged and processed without user knowledge and approval, and stored until the moment when user accesses some content on the Internet.

Existing ways of collecting user data are limited in terms of data availability, and they often seriously violate consumer privacy. Existing advertising modes also entirely depend on the user access to web sites, so without accessing the right page, the user will not see commercial.

### SUMMARY OF THE INVENTION

Digital advertising deals with delivery of digital advertisements in the form of images, animations, video and audio content and their display on user computers and smart mobile devices. In the following text all these devices will be treated as computers.

Opposite from classic digital advertising methods, where selection of advertisement is done outside of the user computer, on remote locations, here the selection is done locally, inside the user computer. The advertisements are regularly created by Advertisers which store them on Advertising servers. Beside advertisements, the Advertisers also define desired profile of targeted consumers through graphic user interface and then let Advertising server insert the desired profiles in a List of desired profiles. The List is then delivered to the local computer. When user computer receives the List, it compares the List's content with the profile of local user and if some of desired profiles match the local profile the associated advertisements are selected as the most appropriate candidates for displaying.

After the profiles comparation finishes, the offered prices for candidate advertisements are extracted from profile and the local bidding process starts. The result of bidding process is one or few advertisements that will be displayed to consumer.

With this method and system, instead of being passive and just receiving pre-selected advertisements, a user computer is active in profiling user, analyzing behavior and interests, selecting the advertisements and displaying them.

In order to apply these features, it is necessary to implement a special Agent Module for advertising, self-profiling and content analysis (hereinafter—the Agent Module). The Agent Module is a software entity that performs several functions.

The first Agent Module function is to display advertising content on a computer screen or device display. This means that when necessary, the advertisements can be displayed independently from any other application, including web browsers. This is a significant advantage of this invention because it ensures that the advertisement is inevitably displayed, independently from visited website or the application start.

The second Agent Module function is self-profiling. The Agent Module analyses consumer behavior on the local computer and generates the Dynamic profile of the individual user. This profile is used for precise targeted advertising. In other words, a proposed advertisement is displayed only to the user whose profile is the most appropriate. In this way, the money invested in advertising is effectively used only where it makes sense. Local Self-profiling also means that all user related data, generated in this process, remain located in the user computer, since there is no need to share the data. This way user privacy is maximally protected.

The Agent Module is installed on user computer and started every time operating system starts. It has the appropriate program interface related to security program, operating system or some other locally installed application capable to intercept the traffic that comes to or goes from a computer and checks it before sending it further. This interception is used to analyze the content interesting to user, which is important for a precise marketing segmentation and direct targeting. Traffic interception also provides an ability to modify the traffic, to insert new content or exclude some. This particularly applies to web content where advertising content can be inserted. The program interfaces define the data formats and modus of their exchange, as well as the mutual signaling.

### BRIEF DESCRIPTION OF THE DRAWINGS

FIG. 1—Internet digital advertising, in general

FIG. 2—Internet digital advertising, web

FIG. 3—Internet digital advertising, through other applications

FIG. 4—Internet digital advertising, use of security programs

FIG. 5—User computer selects advertisements

FIG. 6—Dynamic consumer profile structure

FIG. 7—Desired consumer profile structure

FIG. 8—Advertising server and Agent Modules

FIG. 9—Advertising server

FIG. 10—Agent Module, Security program, Operating system and Applications

FIG. 11—Agent Module structure

FIG. 12—Security program in a computer system

FIG. 13—The Agent Module as an add-on to security program

FIG. 14—The Agent Module directly attached to operating system

FIG. 15—Dynamic user profile storage file attached to Agent module

FIG. 16—Questionnaire for initial Dynamic consumer profile setup

FIG. 17—Copying web content, intercepted by security program, for further analysis

FIG. 18—Copying web content, intercepted by operating system, for further analysis

FIG. 19—Monitoring user actions in web browser, intercepted by security program, for further analysis

FIG. 20—Monitoring user actions in web browser, intercepted by operating system, for further analysis

FIG. 21—Monitoring user actions, directly intercepted by operating system, for further analysis

FIG. 22—Direct download of Advertisements and List of desired consumer profiles by the Agent Module

FIG. 23—Downloading Advertisements mixed with Security program updates

FIG. 24—Downloading List of desired profiles mixed with Security program updates

FIG. 25—Direct downloading Advertisements by operating system

FIG. 26—Direct downloading List of desired profiles by operating system

FIG. 27—Downloading simultaneously set of advertisements and List of desired profiles and selecting the most appropriate advertisement to display immediately

FIG. 28—Downloading simultaneously set of advertisements and List of desired profiles and selecting the most appropriate advertisement to display after bidding

FIG. 29—Downloading List of desired profiles first, selection and download Advertisement and Advertisement display immediately

FIG. 30—Downloading List of desired profiles first, selection and download Advertisement and Advertisement display after bidding

FIG. 31—Advertisement impression in independent window

FIG. 32—Advertisement in Application window

FIG. 33—Displaying Advertisement in the form of web content

FIG. 34—Inserting web content by Agent Module attached to Security program

FIG. 35—Inserting web content by Agent Module attached to operating system

FIG. 36—Flowchart of the forced insertion of advertising content in intercepted web traffic

FIG. 37—Flowchart of the process for inserting advertising content in intercepted web traffic based on a special code or tag

The drawings 1 to 37 in many cases contain the same items differently numbered, depending on drawing content. Here is a list of items which have different numbering:
Advertising servers—101, 201, 301, 401, 501, 801, 901
Internet—120, 220, 320, 420
Advertisement—130, 230, 330, 430, 530, 2230, 2330, 2530, 3130, 3230
Personal computer—150, 250, 350, 450, 550
Mobile smart device or phone—140, 240, 340, 440, 540
Security program—409, 1009, 1209, 1309, 1509, 1709, 1909, 2309, 2409, 3409
Application—308, 1008, 1208, 3208
List of desired profiles—510, 710, 2210, 2410
Agent module—838, 1038, 1138, 1438, 1538, 1738, 1838, 1938, 2038, 2138, 2238, 2338, 2438, 2538, 2638, 3138, 3238, 3338, 3438, 3538
Operating system—1039, 1239, 1439, 1739, 1839, 1939, 2039, 2139, 2539, 2639, 3439, 3539
Dynamic user profile file—1556, 1656, 1756, 1856, 1956, 2056, 2156
Computer screen or display—1657, 3157, 3257
Web browser—1759, 1859, 1959, 2059, 3259, 3359, 3459, 3559
User actions—1962, 2062
Copy of user actions—1963, 2063
Web content—1760, 1860, 3460, 3560
Web content copy—1761, 1861

### DETAILED DESCRIPTION OF THE INVENTION

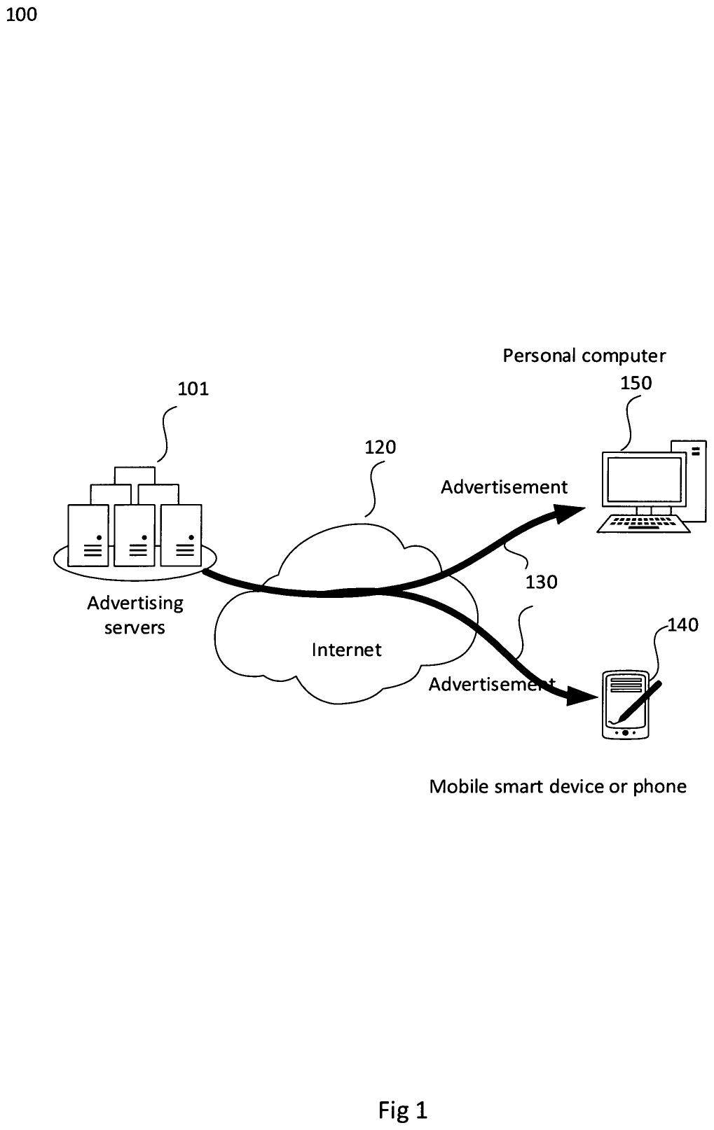

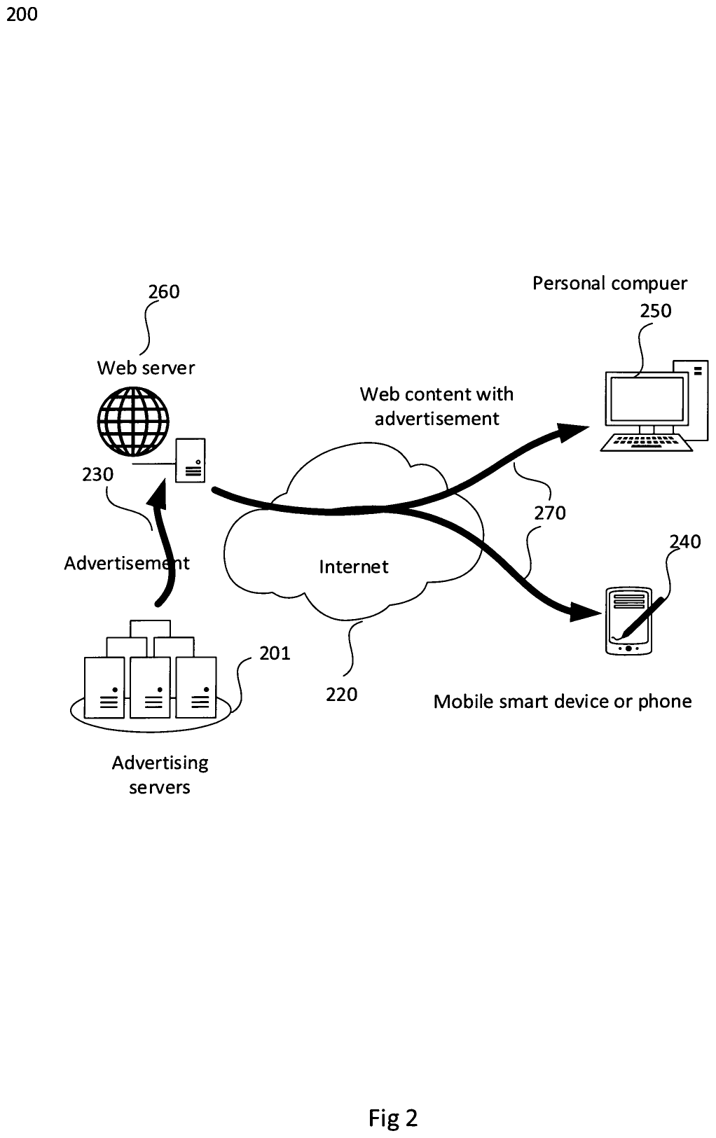

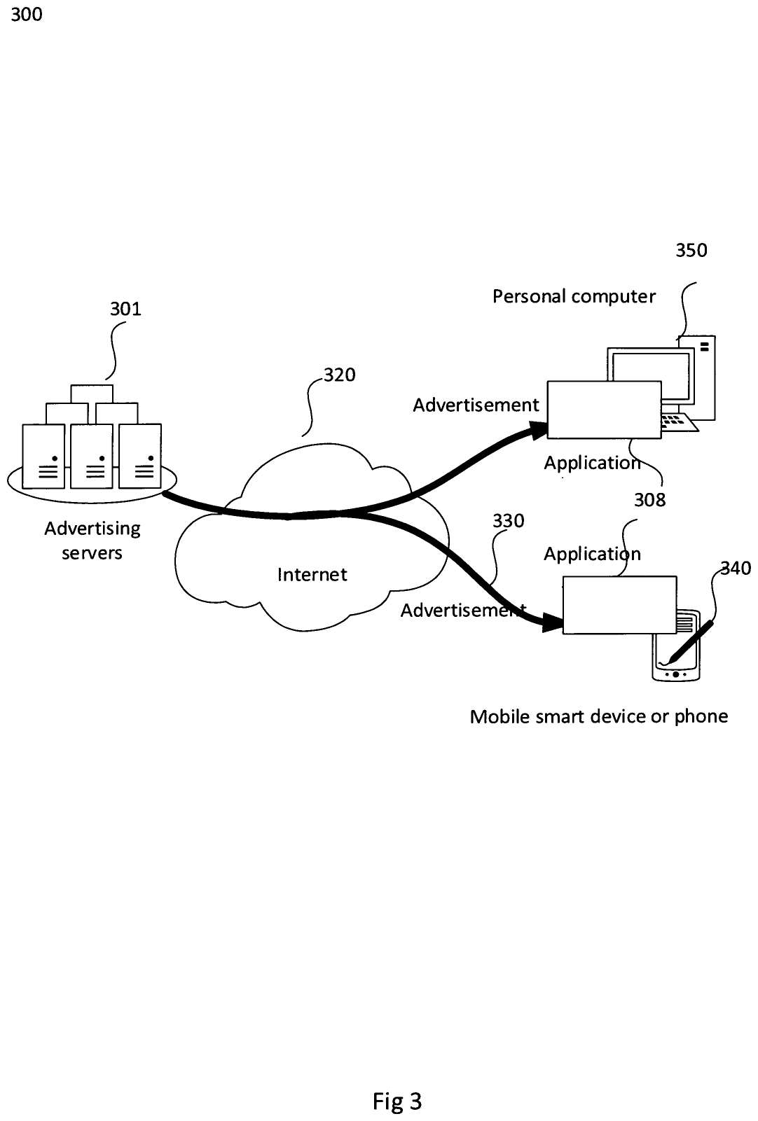

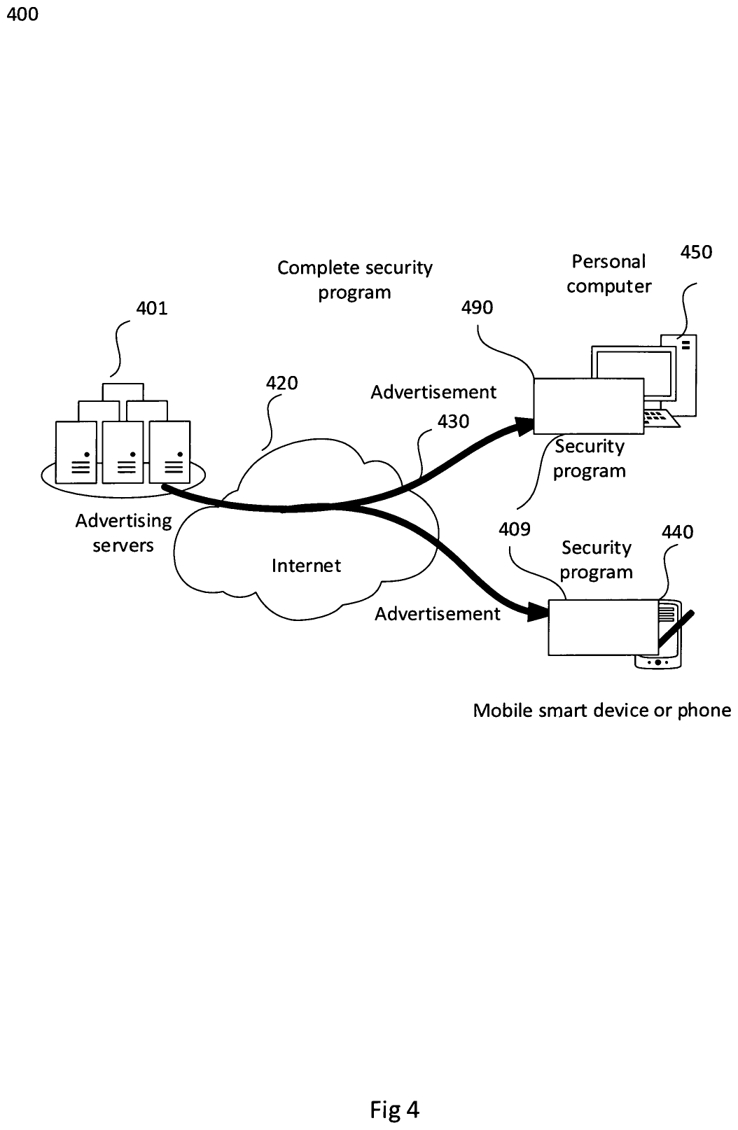

The main goal of digital online advertising (FIG. 1) is to enable advertisers to deliver their advertisements 130 as efficiently as possible over the Internet 120 from Advertising servers 101 to user personal computers 150 or other portable smart devices 140. In most cases, advertisements 230 are not delivered directly, but through the corresponding websites (FIG. 2) located on remote web servers 260, so advertisements and web contents are ensembled and transmitted together 270 from Web servers 260 to user devices 240 or 250. There are also variants (FIG. 3) of advertising by various user applications 308 (which can be programs, games etc.) where the advertisement 330 is first forwarded to the application 308, which then displays the advertisement to the person who use the application. A special case of advertising by application is given in the (FIG. 4) where Security program based on antivirus protection 409 is used for advertising delivery.

The main characteristic of the classic digital advertising systems is that user computer (150, 250, 350 or 450) or smart mobile device (140, 240,340 or 440) has a passive role, displaying advertisements selected at some other place. All analytics and user profiling are done centrally and remotely, at Advertiser servers (101, 201, 301 or 401) or some other remote location. Consumers and consumer devices have no influence which advertisement is going to be displayed.

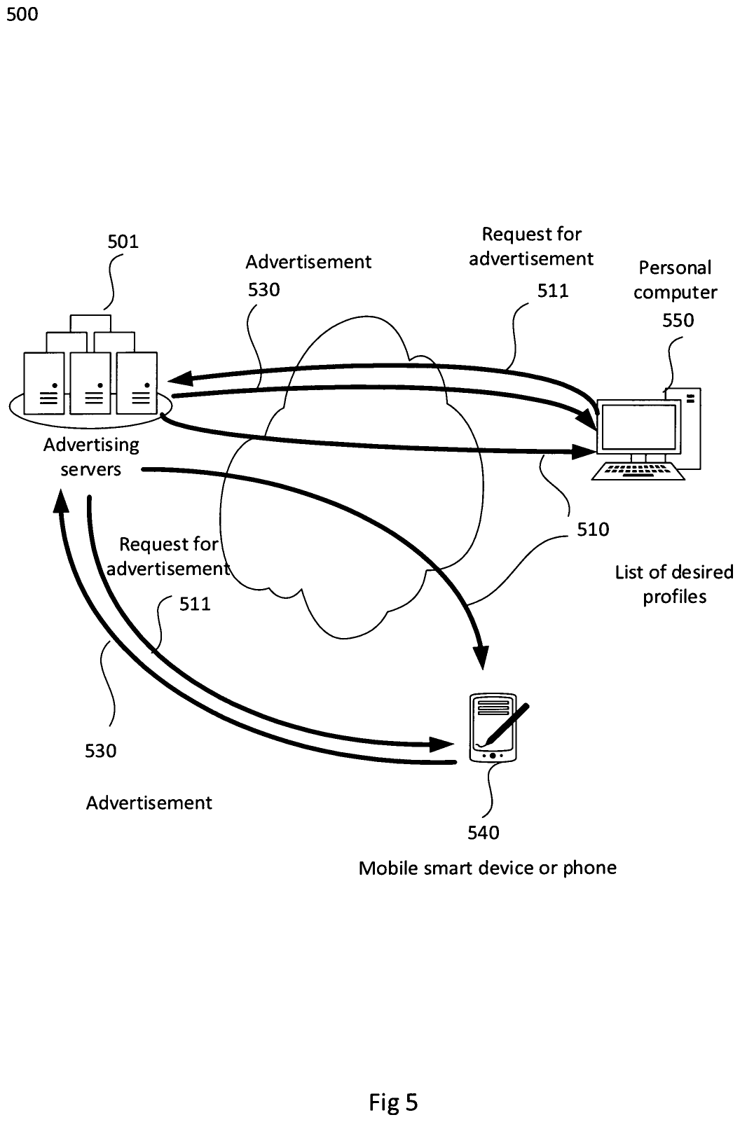

This invention creates quite the opposite situation, because user computers 550 or 540 have active role in advertisement selection and user profiling, as well as in advertisements download and displaying. All the Advertisers have to do is just to prepare advertisements 530 and to identify desired profiles of local consumers to whom the advertisements 530 should be displayed. However, the Advertisers know nothing about real consumers, since with this concept there is no need for Advertisers to have such information. All decisions regarding which advertisement to download and display to which consumer are made locally (FIG. 5), according to profile of the local consumer, made separately for every single consumer. Advertisers just propose List of desired user profiles 510, and let the consumer computer 550 or mobile device 540 to do the rest of the job—check profiles matching, Request for advertisements (511), download and display them.

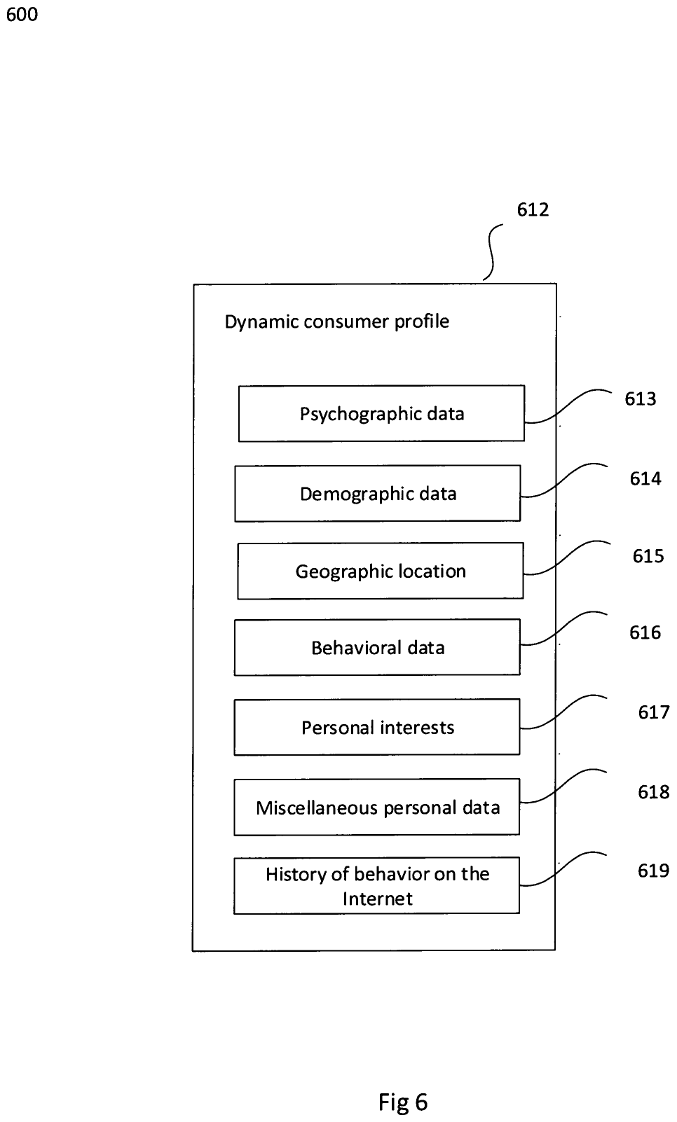

Dynamic consumer profile 612 (FIG. 6) is a data structure made of Psychographic data 613, Demographic data 614, Geographic location data 615, Behavioral data 616, Personal interests 617, Miscellaneous personal data 618, History of behavior on the Internet 619. A dynamic consumer profile 612 is completely made by local user computer and it never leaves the local computer. This way consumer privacy is protected.

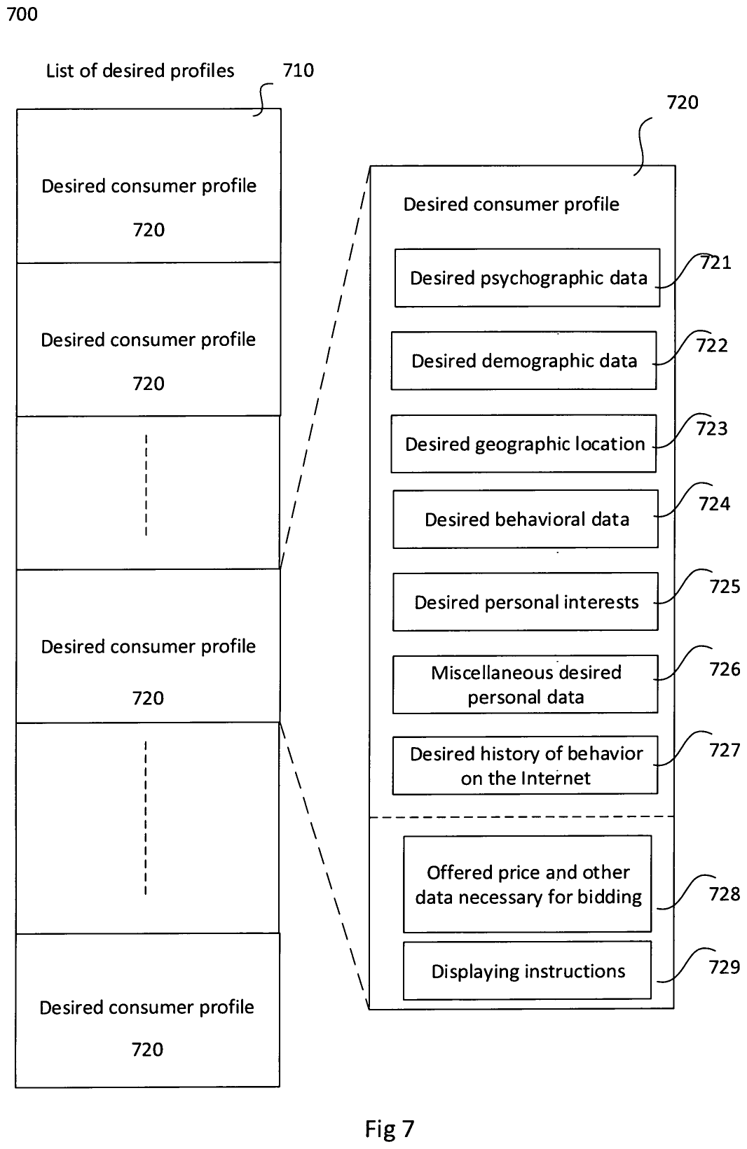

Desired consumer profile 720 (FIG. 7) is a data structure that mostly corresponds to Dynamic consumer profile 612 data structure, with additional data set. Consequently, the Desired consumer profile 720 consists of Desired psychographic data 721, Desired demographic data 722, Desired geographic location data 723, Desired behavioral data 724, Desired personal interests 725, Miscellaneous desired personal data 726, Desired history of behavior on the Internet 727. Additional data set is Offered price and other data necessary for bidding 728 and Displaying instructions 729. A set of active Desired consumer profiles 720 is placed in a List of desired consumer profiles 710. Desired consumer profiles 720 are made by Advertisers on remote Advertising servers, after which they are packed into Lists of desired consumer profiles 710.

When mentioned that Desired consumer profile 720 and Dynamic consumer profile 612 correspond each other, this means that Psychographic data 613 has the same data type and structure as Desired psychographic data 721, Demographic data 614 has the same data type and structure as Desired demographic data 722, Geographic location data 615 has the same data type and structure as Desired geographic location data 723, Behavioral data 616 has the same data type and structure as Desired behavioral data 724, Personal interests 617 has the same data type and structure as Desired personal interests 725, Miscellaneous personal data 618 has the same data type and structure as Miscellaneous desired personal data 726 and History of behavior on the Internet 619 has the same data type and structure as Desired history of behavior on the Internet 727.

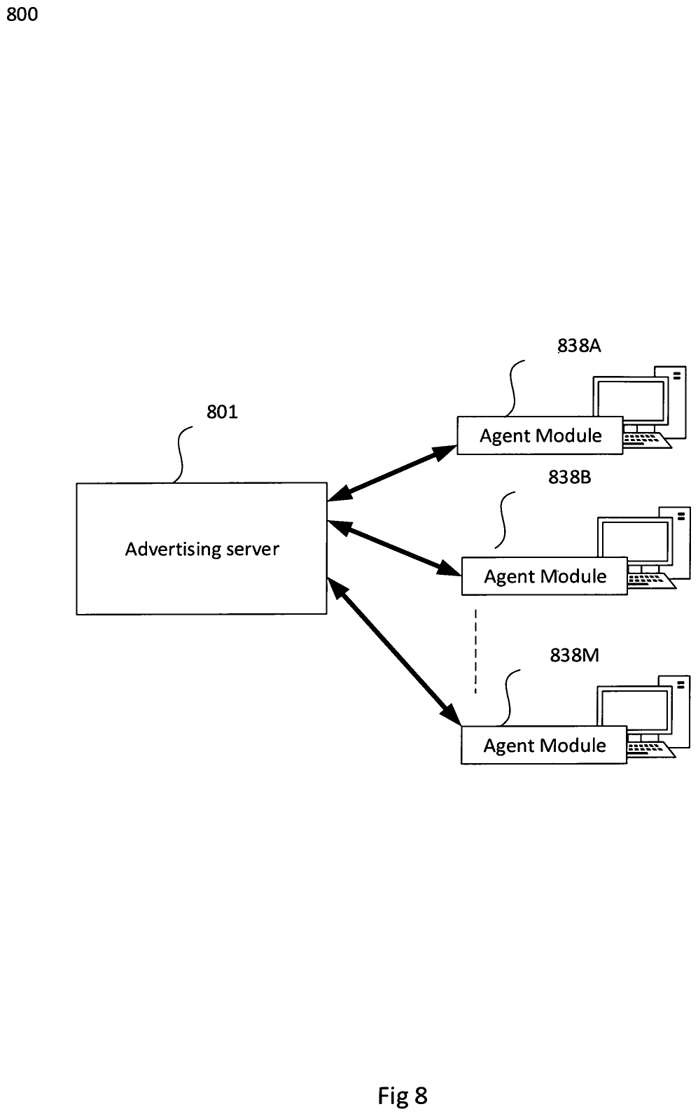

A Self-profiling system for use of security programs or operating systems in digital marketing consists of two major sub-systems (FIG. 8):
Advertising Servers 801
Agent Module 838 installed in every local consumer computer

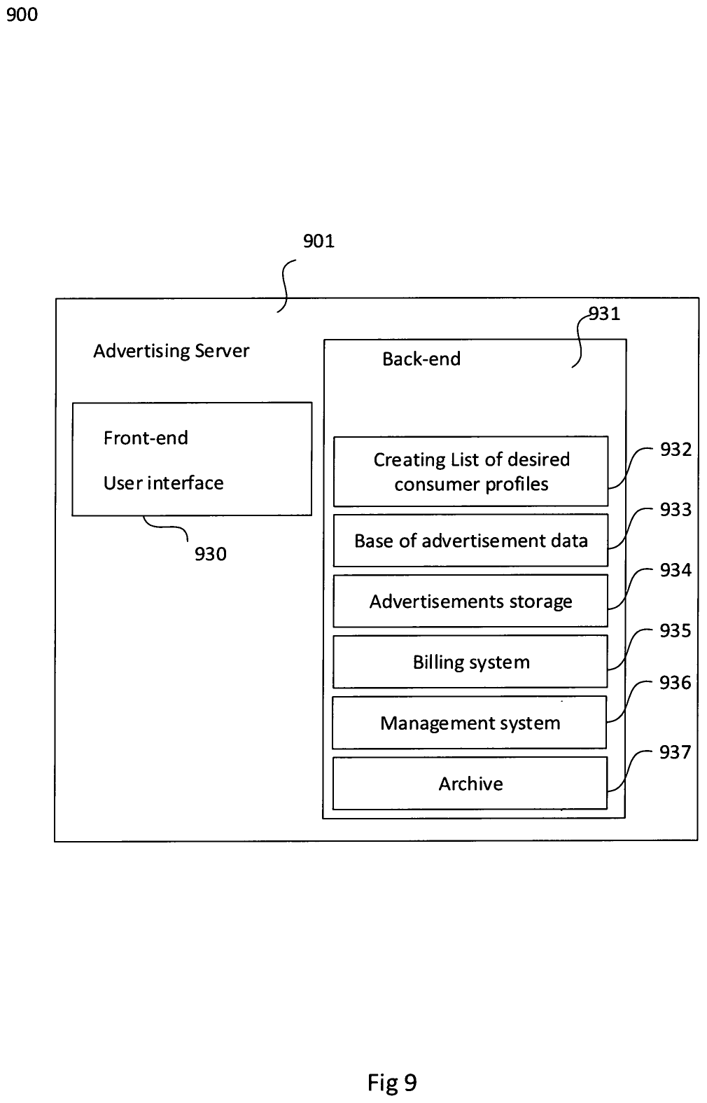

The first subsystem of the Self-profiling system for use of security programs or operating systems in digital marketing is Advertising server 901. Advertising server 901 consists of two main entities (FIG. 9): Front-end User interface 930 and Back-end 931.

Front-end User interface 930 is intended for Advertisers to access the system, specify desired consumer profiles and upload advertisements which they want to be displayed to consumers of desired profiles. Besides desired profiles creation and editing, it is used for reports generation and presenting. Front end User interface 930 is graphical interface which allows user logging in the pre-defined account before any other activities. It also allows multiple connections of large number of different users to access the system.

Back-end 931 component is intended for data processing, delivery, communication and storage. The most important Back-end 931 function is Creating List of desired consumer profiles 932. This function 932 collects currently specified Desired consumer profiles 720 by different Advertisers and assembles the List of desired profiles 710. In the simplest option, the List (710) is delivered directly to large number of consumers. In the more sophisticated option, the List of desired profiles (710) is forwarded to the companies that make Security programs, which then include the List 710 into regular updates and deliver it to their consumers. The function Creating list of desired profiles 932 works continuously and at every moment has prepared a current List of desired profiles 710.

Back-end component 931 has also a Base of advertisement data 933 which stores all data necessary for List 710 assembling. Back-end also has Advertisement storage 934 which stores currently active Advertisements. All advertisements and appropriate data which do not belong to any active campaign are placed into Archive 937. The Billing 935 is important function of Back-end 931 because it keeps records of the realized impressions and invoicing. All activities of Back-end are supervised and controlled by Management system 936.

Although the Advertisement server does not have to be located on a single physical server nor single physical location, it is still unified logical functional entity.

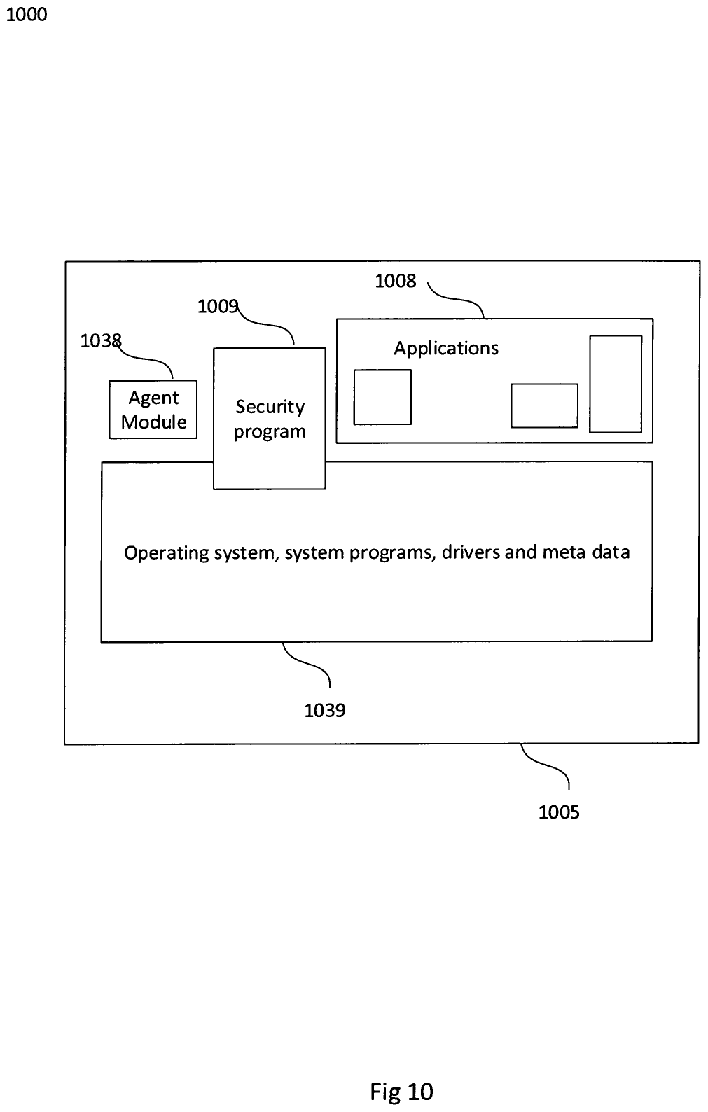

All operations in a local computer are done by second sub-system of Self-profiling system for use of security programs or operating systems in digital marketing—a special multifunctional Agent Module 1038 (FIG. 10). The Agent Module 1038 is a piece of software installed on user computer 1005 or mobile device, and is responsible for advertisement selection, download and displaying, as well as for data analytics which concerns Dynamic consumer profile 612 creation and maintenance. The Agent Module 1038 can operate as a standalone application or better as an add-on to the operating system 1039, security program based on antivirus protection 1009, web browser or some other application 1008. No matter of operating mode, in order to update and maintain Dynamic consumer profile 612, the Agent Module 1038 have to be able to monitor and analyze user behavior and interests, using data intercepted during transfer to and from local computer, system and programs start etc. Probably the best way to intercept this data is to leave it to Security program based on antivirus 1009 or to operating system 1039 and to relax Agent Module 1038 from these functions.

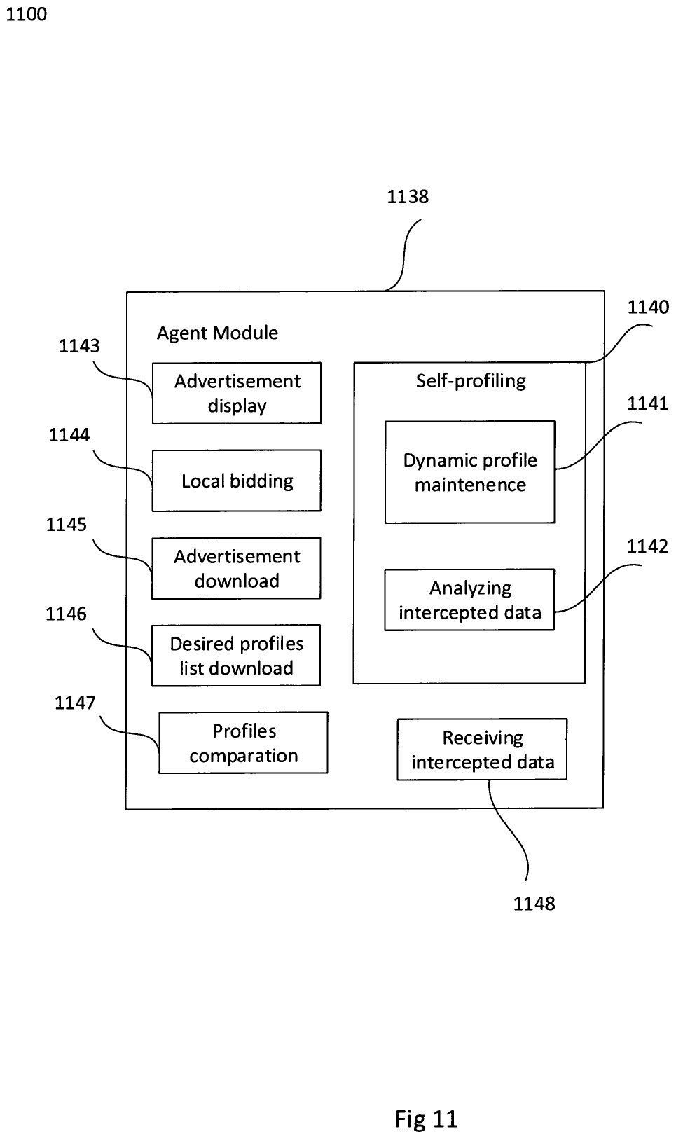

The Agent Module 1138 contain several functions (FIG. 11). Self-profiling 1140 is a function dedicated to creation and maintenance of local consumer Dynamic profile. Self-profiling function 1140 itself contains two functions: Dynamic profile maintenance 1141 and Analyzing intercepted data 1142. Dynamic profile maintenance 1141 directly works with local consumer Dynamic profile, accesses and updates its data. Dynamic profile is created at the start of Agent Module 1138 installing on the local computer, usually by filling a questionnaire. After that, during the regular system operations, the Dynamic consumer profile 612 is modified and updated according to the consumer behavior analysis. Function Analyzing intercepted data 1142 receives all data about consumer behavior on the Internet or on the local computer generally, analyzes the data and updates the Dynamic consumer profile 612. The data necessary for Analyzing 1142 is intercepted by Security program or Operating system and forwarded to the Agent Module 1138 by the function Receiving intercepted data 1148.

Agent Module 1138 has function Desired profiles list download 1146 which downloads a List of desired consumer profiles 710 created by Advertisers. The List of desired consumer profiles 710 can be downloaded in three ways: by Security program 1009 and delivered to the Agent Module 1138, by Operating system 1039 and delivered to the Agent Module 1138, or directly by Agent Module 1138 itself.

Agent Module's 1138 function Profiles comparation 1147 is used to compare the local Dynamic consumer profile 612 with every single profile from the received List of desired profiles (710). Since every individual Desired consumer profile 720 has data structure which corresponds to the structure of Dynamic consumer profile 612, with exception of Offered price and data necessary for bidding 728 and Displaying instructions 729, comparation is done only for data sets in both profiles 612 and 720 that correspond each other.

Agent Module's 1138 function Local bidding 1144 is used to select the advertisements for display. This function starts after Profiles comparation 1147 is finished and a set of candidates for displaying is made. In Local biding 1144 data from Offered price and data necessary for bidding 728 are extracted and according them conducted bidding procedure, which results by one or more selected profiles whose associated Advertisements should be downloaded by the function Advertisement download 1145 and displayed by the function Advertisement display 1143.

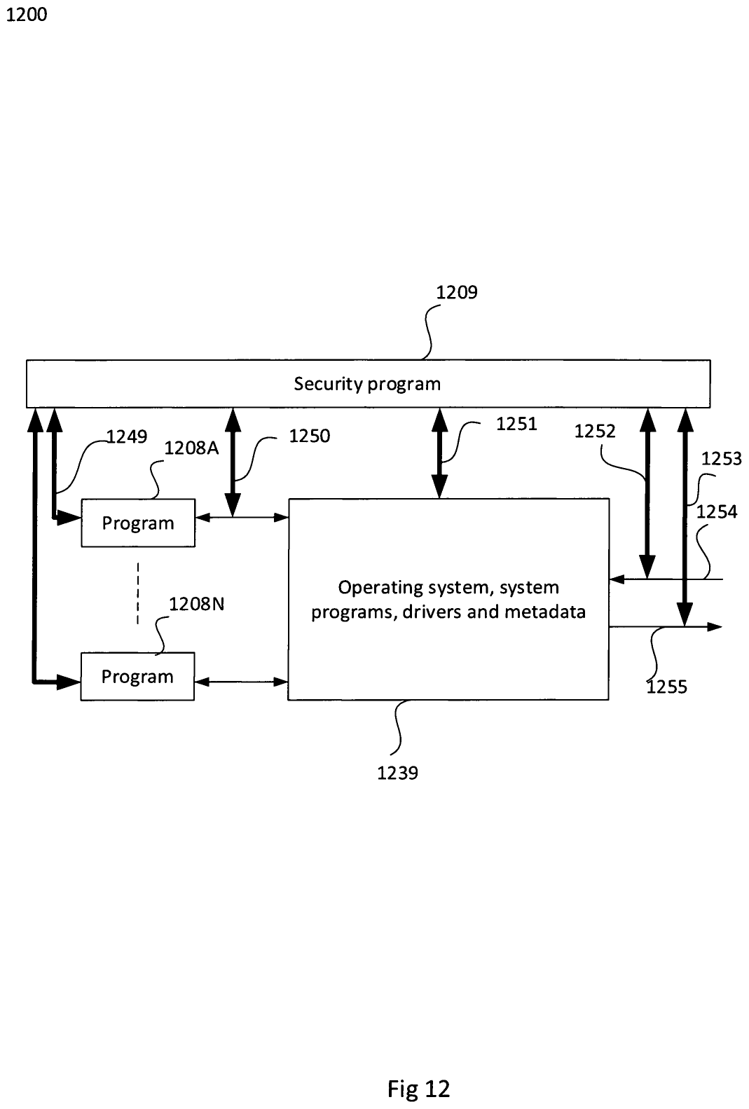

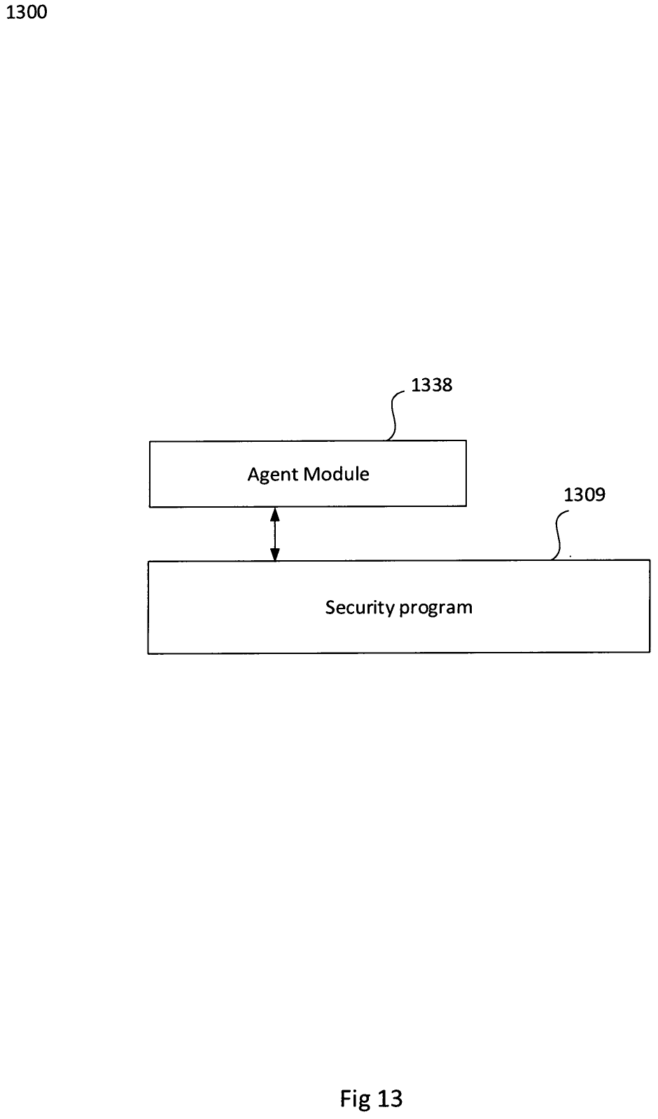

First, and probably most effective way to implement Agent Module 1138 is by attachment to Security programs which contain antivirus function 1209. Security programs 1209 are very special programs (FIG. 12), because they monitor 1249 all other programs 1208 and events in a computer, as well as input and output traffic 1254, 1255 and data on a computer, using corresponding functions for program monitoring 1249, for monitoring program communications 1250, for monitoring input 1252 and output 1253 traffic. The Security program 1209 with its special functions 1251 monitors the operating system, accompanied drivers and meta-data 1239. In most cases (usually with exception of the operating system), Security program 1209 can stop other programs if they are not safe, intercept, alter, and delete problematic data. This way one set of these existing security features is used here in different way—to assist advertising delivery and Self-profiling. In order for a security program 1309 to be used for advertising, it must be slightly modified (FIG. 13) to accept connection with Agent Module 1338.

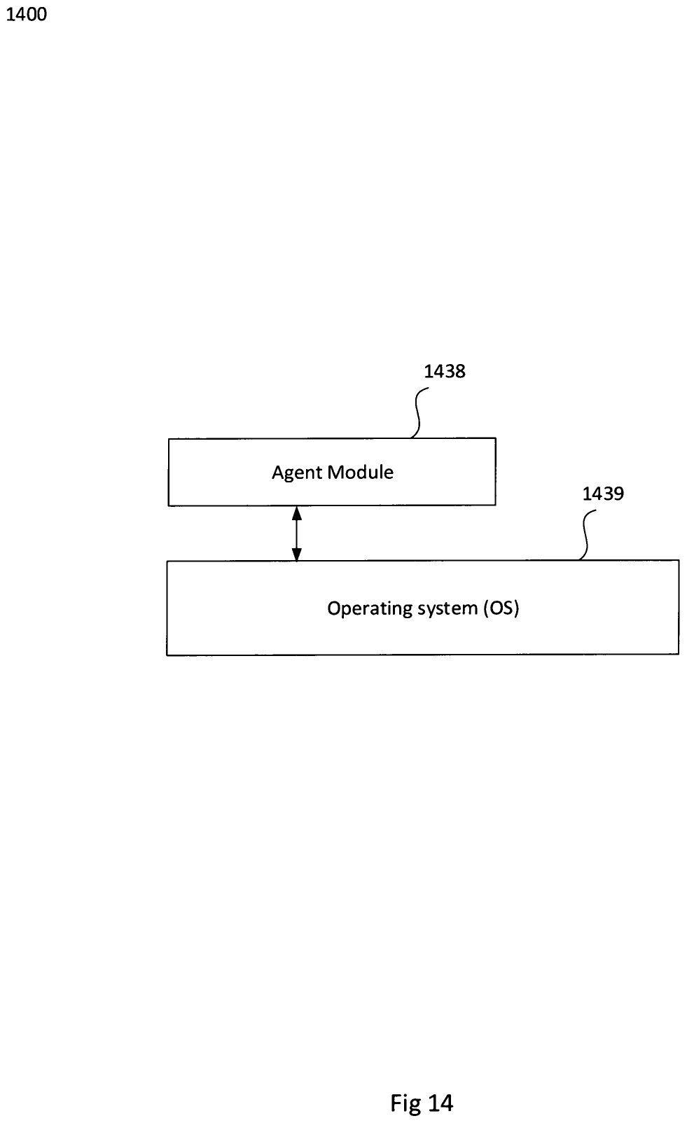

In alternative scenario (FIG. 14), the Agent Module 1438 can be directly attached to the operating system 1439. In that case the operating system's duty is to provide functions for advertising display and data interception.

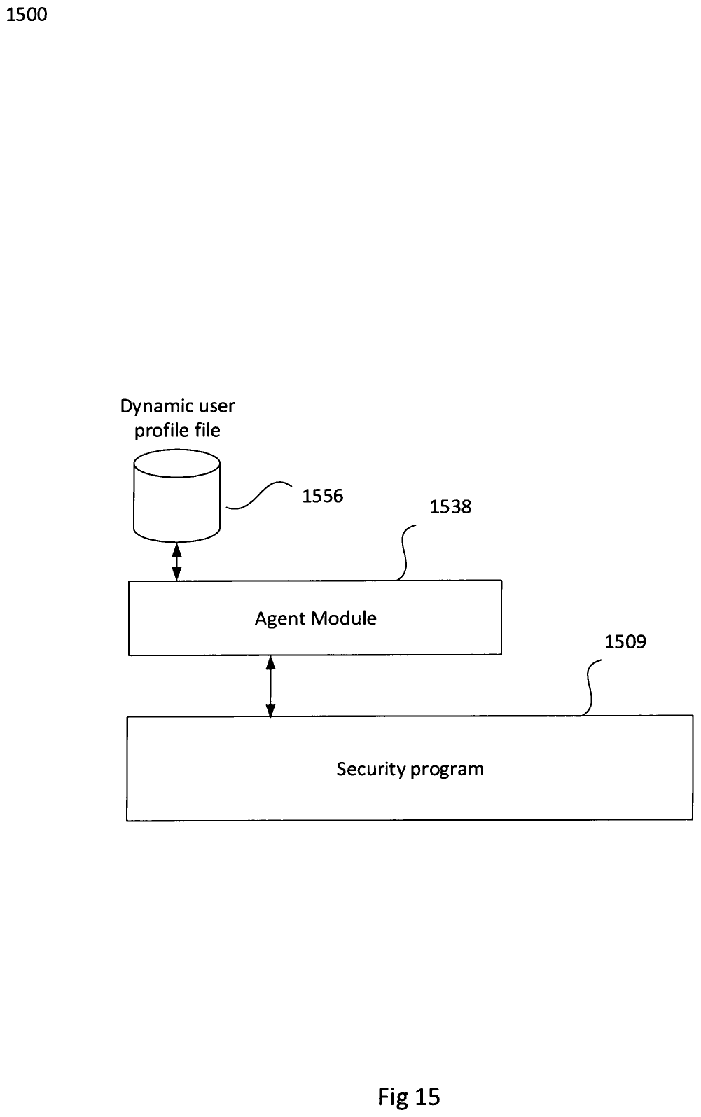

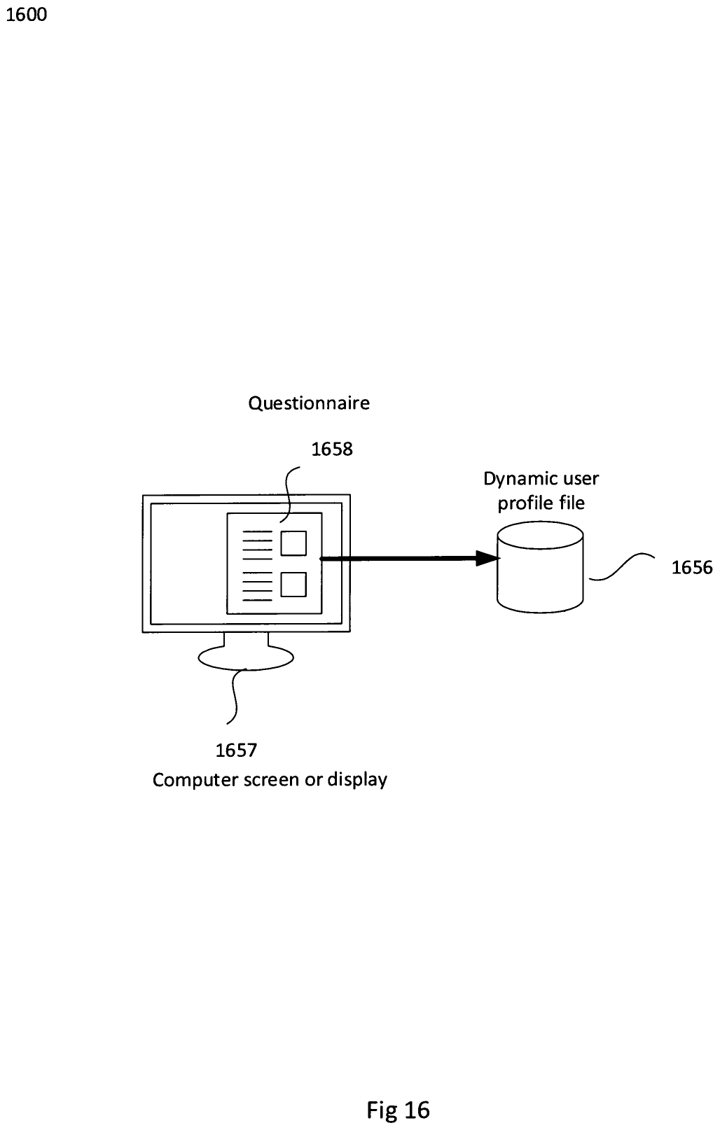

As mentioned before, Self-profiling 1140 function of Agent Module deals with creating and maintenance of Dynamic consumer profile 612. The Dynamic consumer profile 612 is an organized structure of user relating data, relevant for marketing, located in file or database 1556 associated to the Agent Module 1538 (FIG. 15). In that file or database 1556 the Agent Module 1538 stores all Dynamic consumer profile 612 data, having full access to it for creating, modifying and deleting. Initially, after the Agent Module installation is finished, the Dynamic consumer profile 612 doesn't exist and have to be created, the best by consumer action, filling a questionnaire 1658 on its local computer (FIG. 16). After that Dynamic consumer profile 612 becomes truly dynamic, which means it can be upgraded and modified when needed. During regular operations, the Agent Module activates its analytical function 1142 which observe and estimates user behavior and personal interests. After that the Dynamic profile maintenance function 1141 takes control over the Dynamic consumer profile.

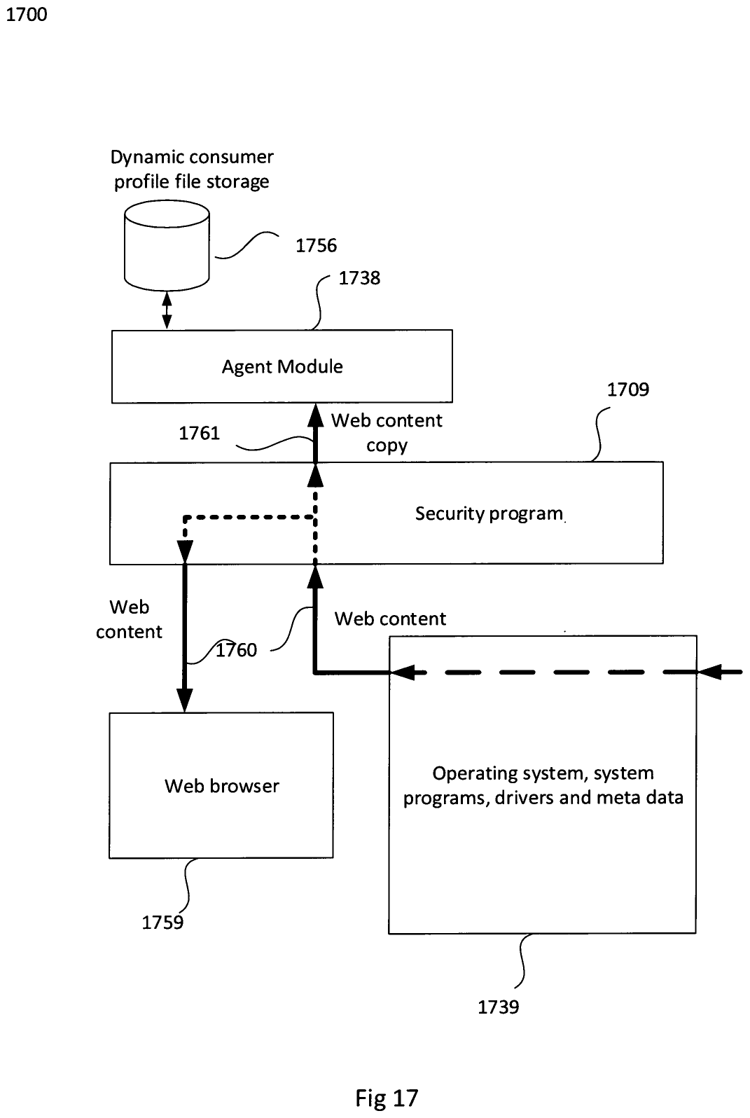

The Agent Module's function Analyzing intercepted data 1142 is mostly executed over a copy of intercepted web data 1760 delivered to the Agent Module 1738 by Security program 1709 after ordinary security check (FIG. 17). Based on this analysis the Agent Module 1738 analytical function 1142 gives information to the Dynamic profile maintenance function 1141 to update the content of Dynamic consumer profile file storage 1756.

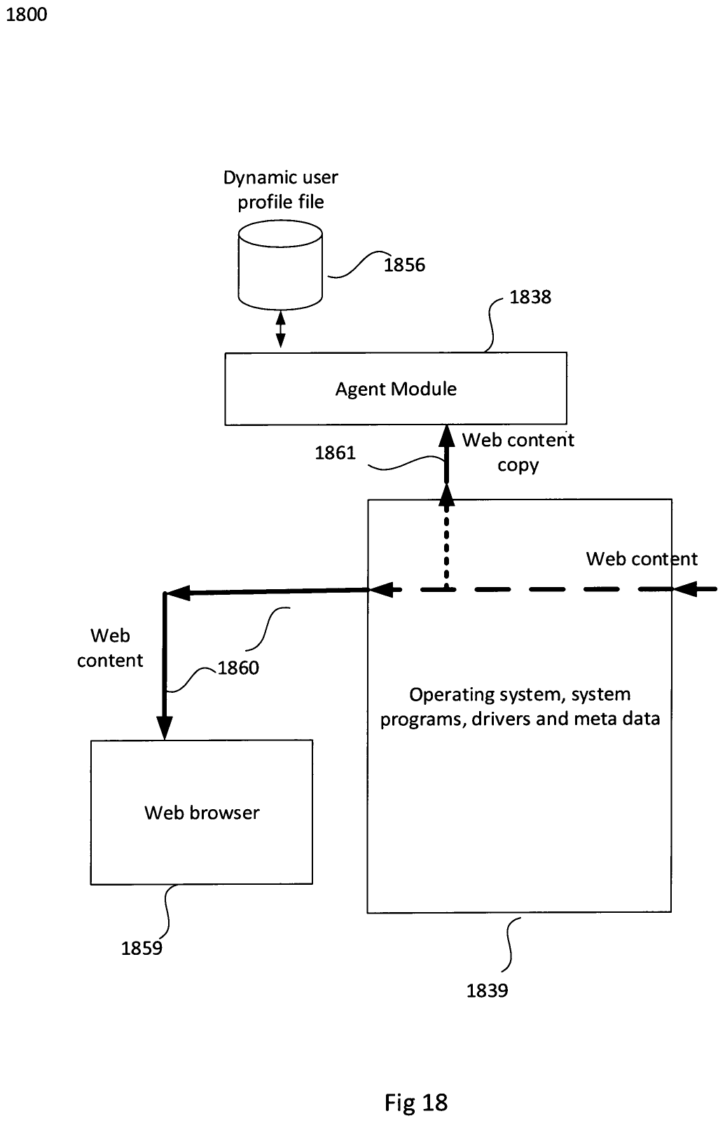

The Agent Module's function Analyzing intercepted data 1142 can be executed over a copy of intercepted web data 1860 delivered to the Agent Module 1838 by operating system directly (FIG. 18). Based on this analysis the Agent Module 1838 analytical function 1142 gives information to the Dynamic profile maintenance function 1141 to update the content of Dynamic consumer profile file storage 1856.

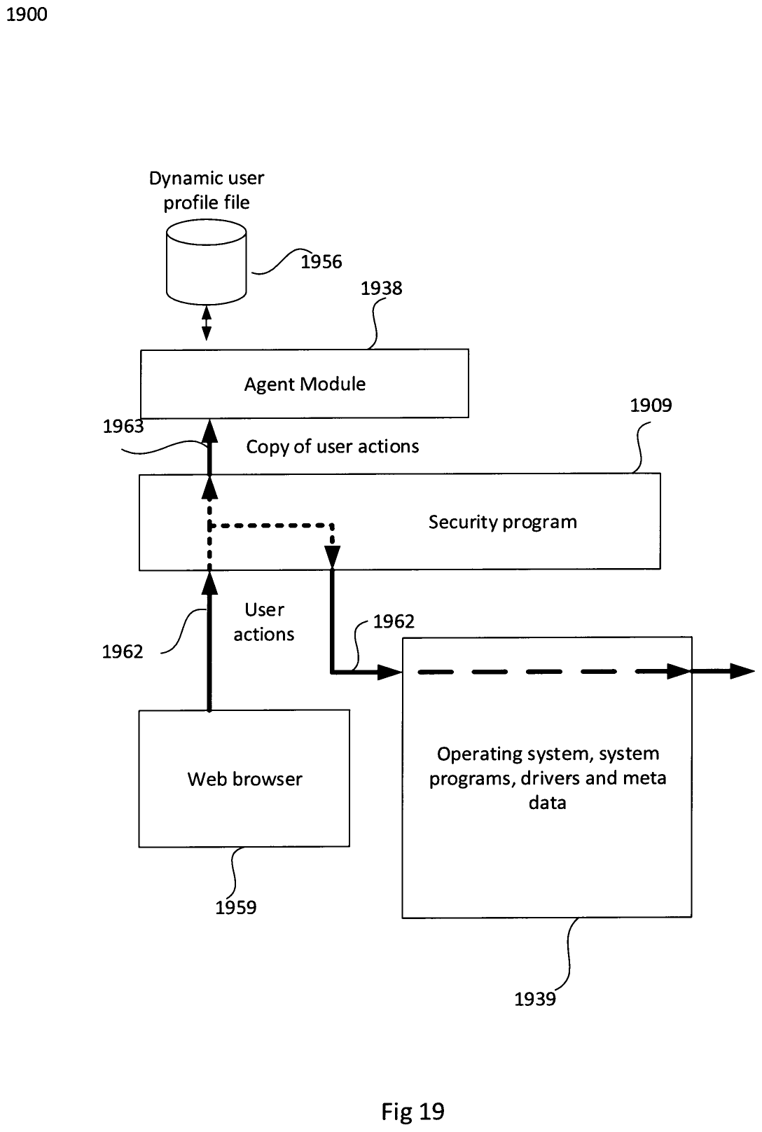

The analytical function 1142 of the Agent Module 1938 attached to Security program 1909 observes user actions 1962 too (FIG. 19). Copy 1963 of the information about every user action on device (enter textual information, selects something in browser or sends it somewhere, etc.) is sent to the Agent Module 1938 for analysis. Based on this information 1963, the Dynamic profile maintenance function 1141 of the Agent Module 1938 additionally updates the Dynamic user profile 612.

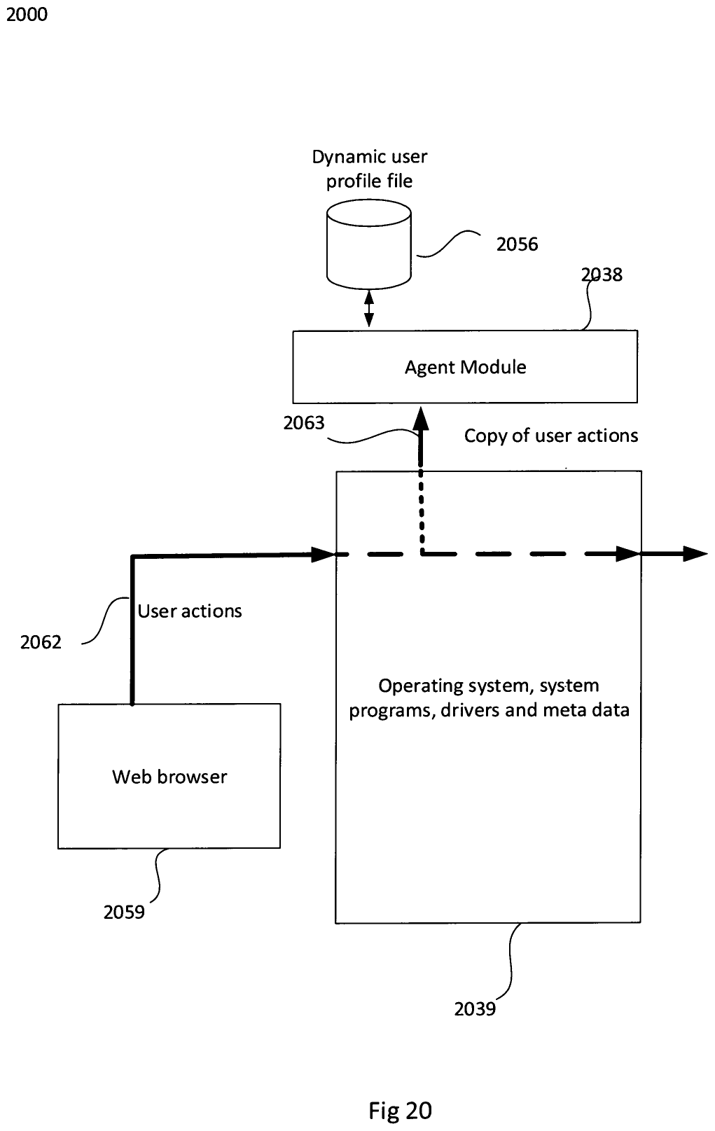

The analytical function 1142 of the Agent Module 2038 attached to the operating system 2039 also observes user actions 2062 (FIG. 20). Copy 2063 of the information about every user action on device (enter textual information, selects something in browser or sends it somewhere, etc.) is sent to the Agent Module 2038 for analysis. Based on this information 2063, the Dynamic profile maintenance function 1141 of the Agent Module 2038 additionally updates the Dynamic user profile 612.

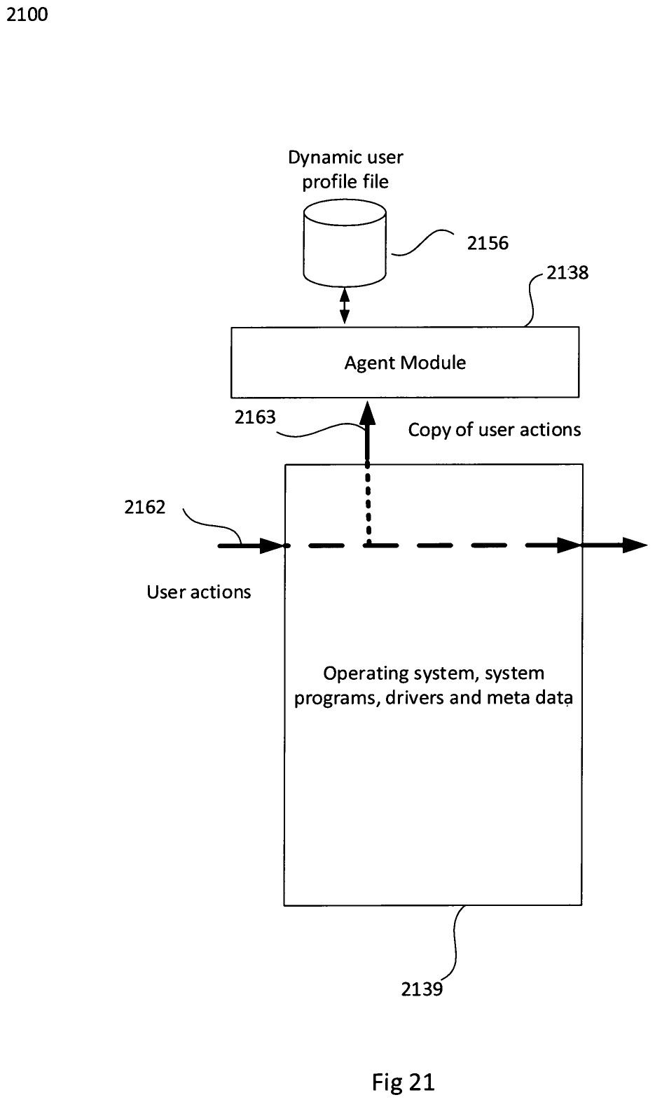

Since there are some user action that are done outside web-browser activities, interception of such user actions can be done directly by operating system 2139 (FIG. 21). Copy of user actions information 2163 is sent to the Agent module 2138, which analyzes them and update the local Dynamic user profile file 2156.

Before profiles comparation and displaying advertisements, the List of desired profiles (710) and the Advertisements (530) both have to be downloaded to the user's computer. Downloading can be done in few ways.

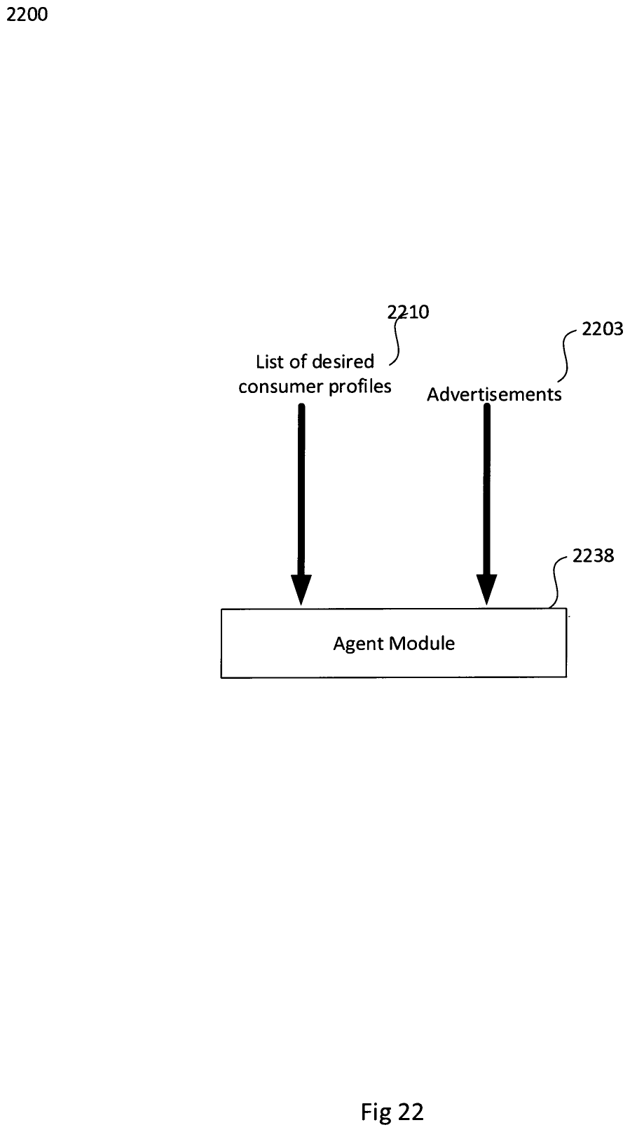

First, the Agent Module 2238 can be designed that Desired profile list download 1146 and Advertisement download 1145 functions have possibilities to access remote locations directly and download List of desired profile 2210 or Advertisements 2230. This option is shown on FIG. 22 and implies that Agent Module 2238 must have its own communication functionality.

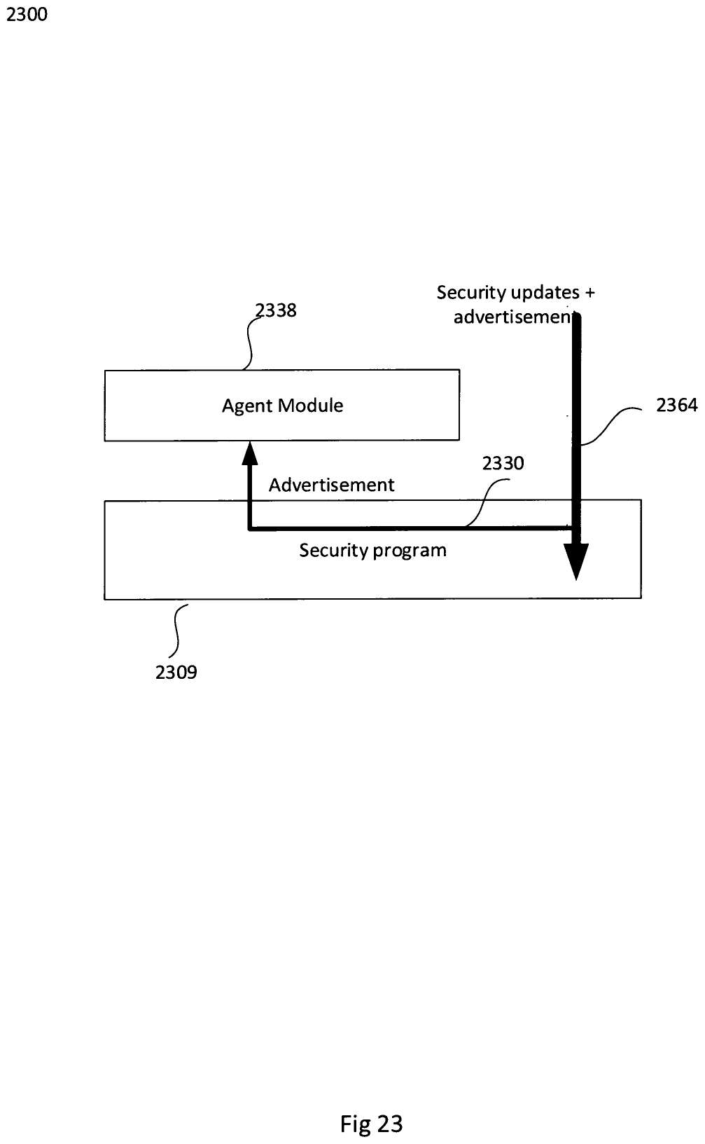

Second, the both kinds of download can be conducted using existing functionalities of Security program 2309, such as regular security update. Every antivirus program depends on regular virus base updates, so this mechanism can be used to attach Advertisements 2330 too (FIG. 23). During the database update, the Security software 2309 retrieves the appropriate files 2364 from a remote location, which consist of the security program updates plus the advertising content. Separation of security bases from advertising content is performed by the Security program 2309 which stores security updates for itself, while forwarding advertising content to the Agent Module 2338.

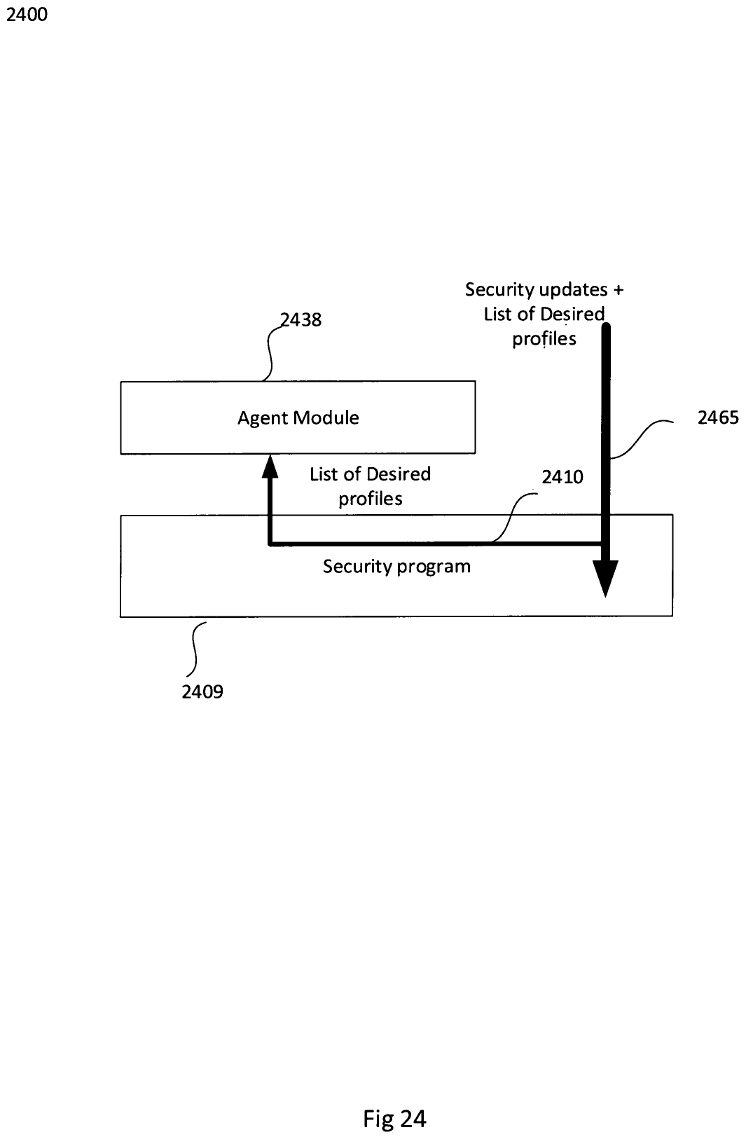

In the same way a List of desired profiles 2410 (FIG. 24) could be attached to regular antivirus base updates. During the database update, the Security software 2409 retrieves the appropriate files 2465 from a remote location, which consist of the security program updates plus the List of desired profiles 2410. Separation of security bases from the List 2410 is performed by the Security program 2409 which stores security updates for itself, while forwarding the List 2410 to the Agent Module 2438.

Of course, the content proposed by advertisers have to be inserted in the update before download. The content can be either complete set of Advertisements 2303 proposed to the local computer or just a List of desired profiles 2410. This way the Agent Module relies on Security program functionality and need no its own communication functions.

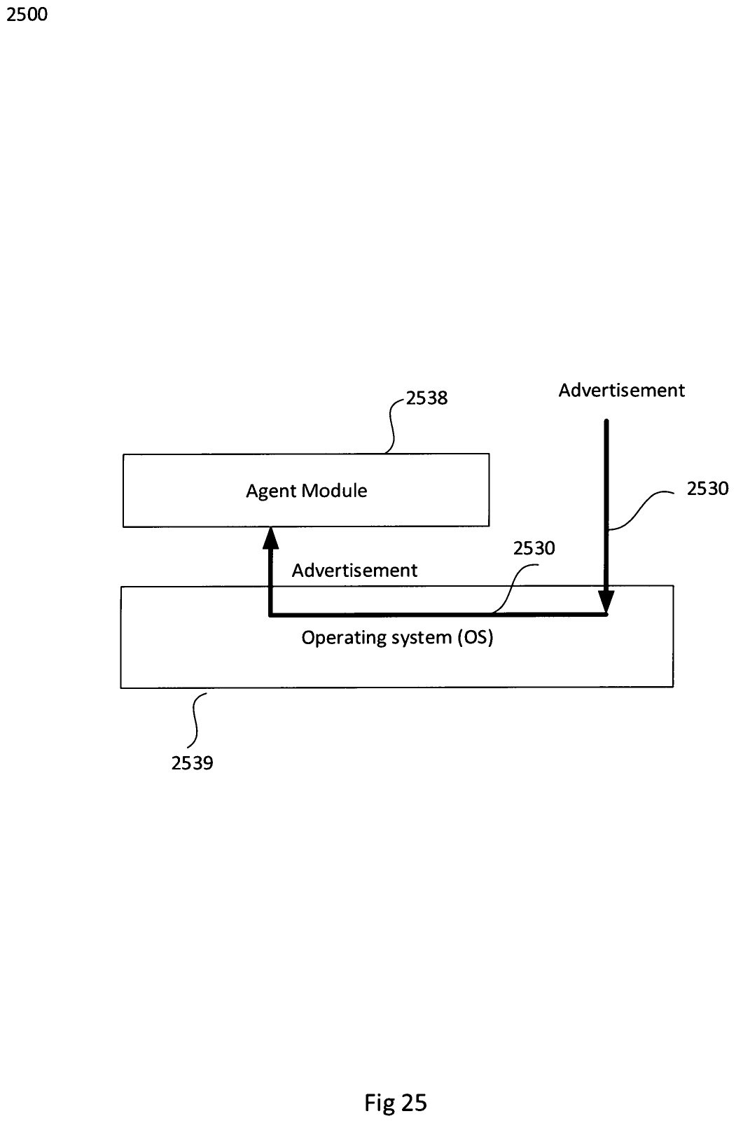

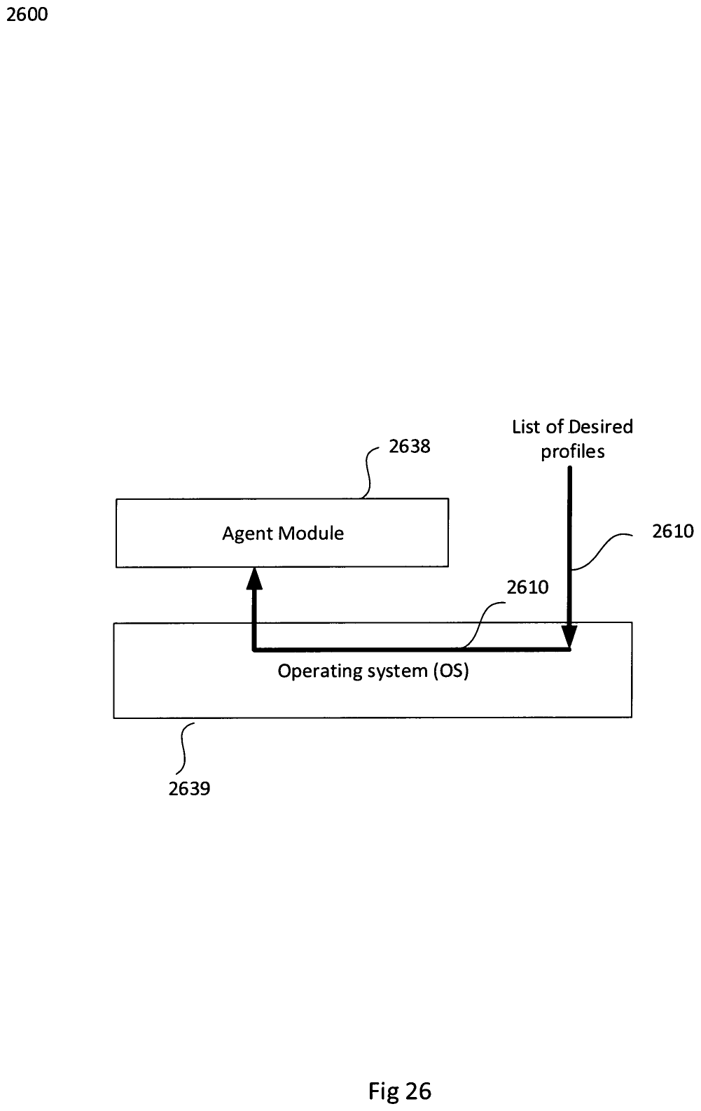

In the same way both kinds of download content (List of desired profiles or Advertisements) can be done using standard functions of Operating system. FIG. 25 shows Agent Module 2538 directly attached to operating system 2539. Downloading advertising content 2530 is done by operating system 2539 functions. This way the Agent Module 2538 relies on Operating system 2539 functionality and need no its own communication functions. FIG. 26 shows Agent Module 2638 directly attached to operating system 2639. Downloading List of desired profiles 2610 is done by operating system 2639 functions.

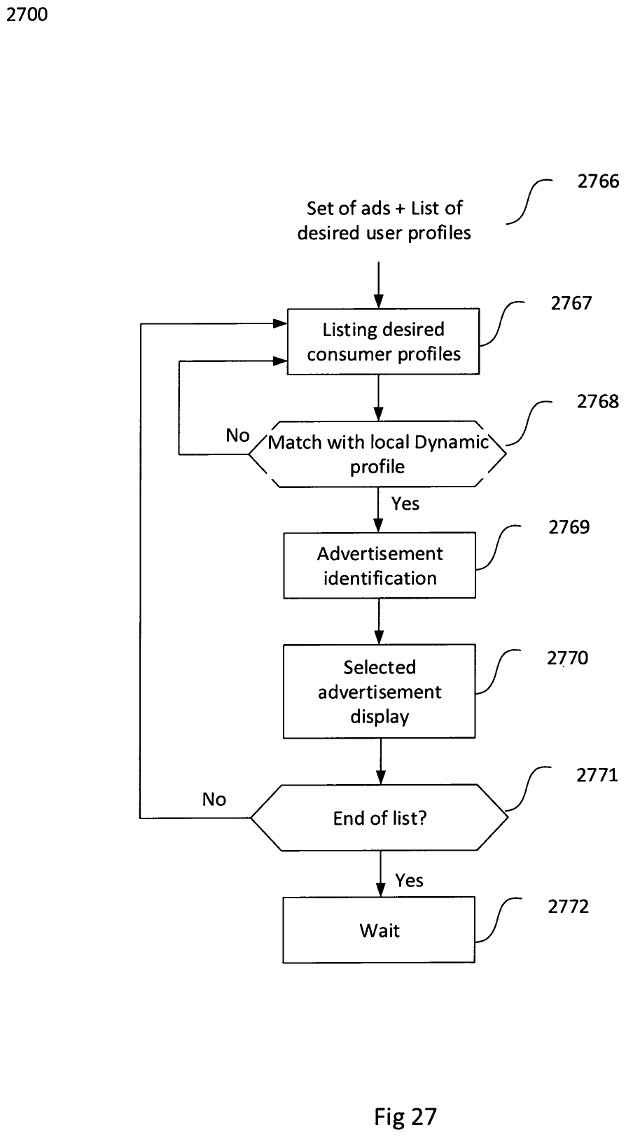

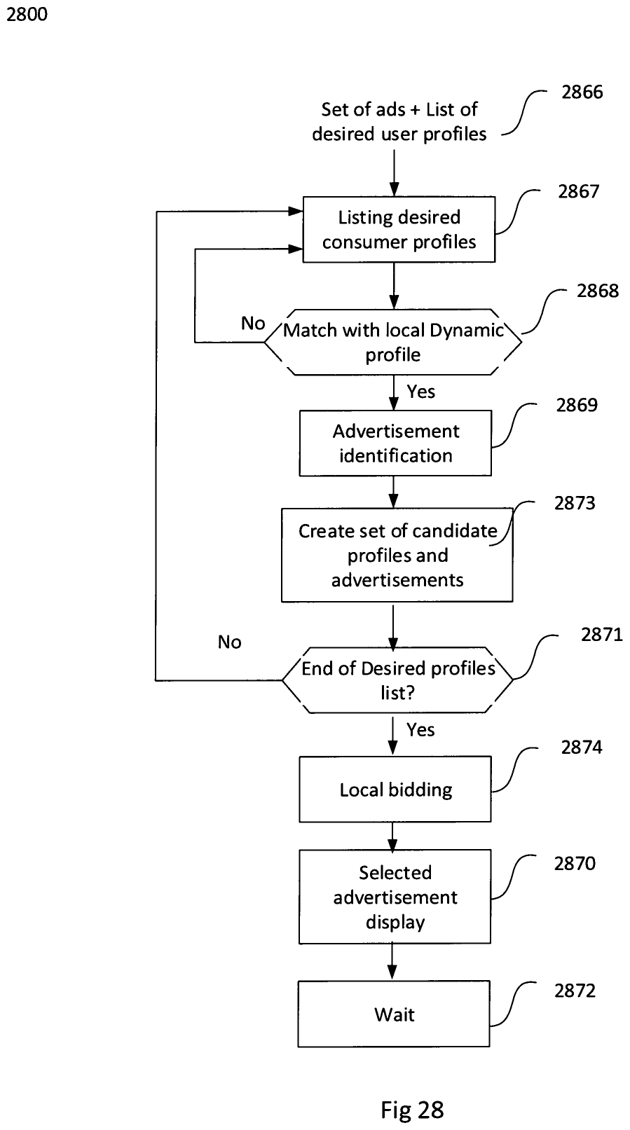

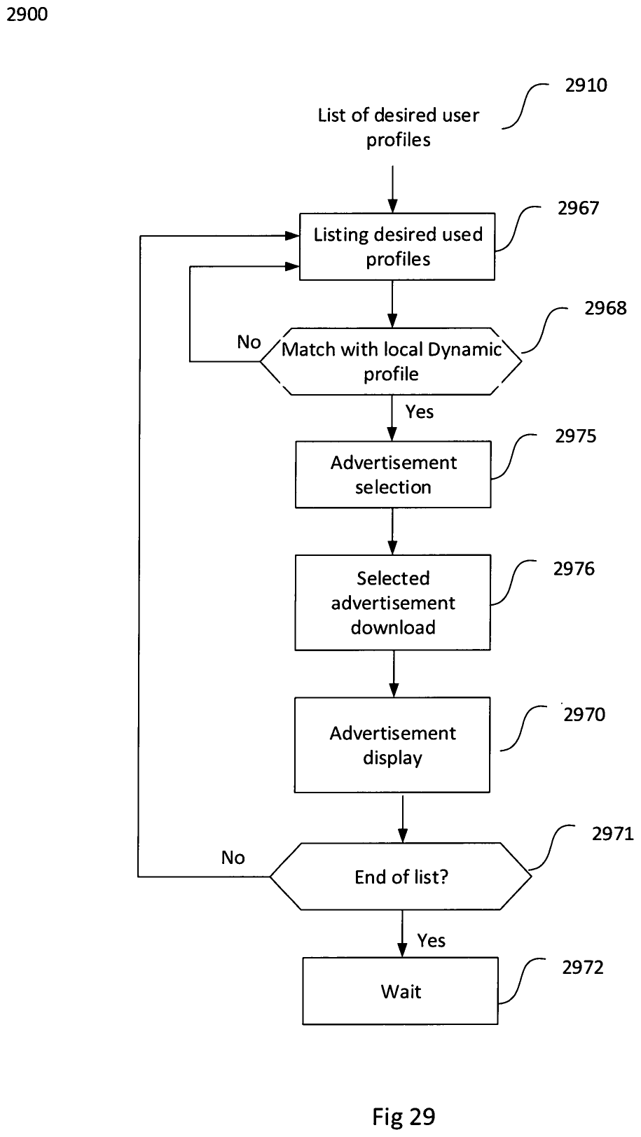

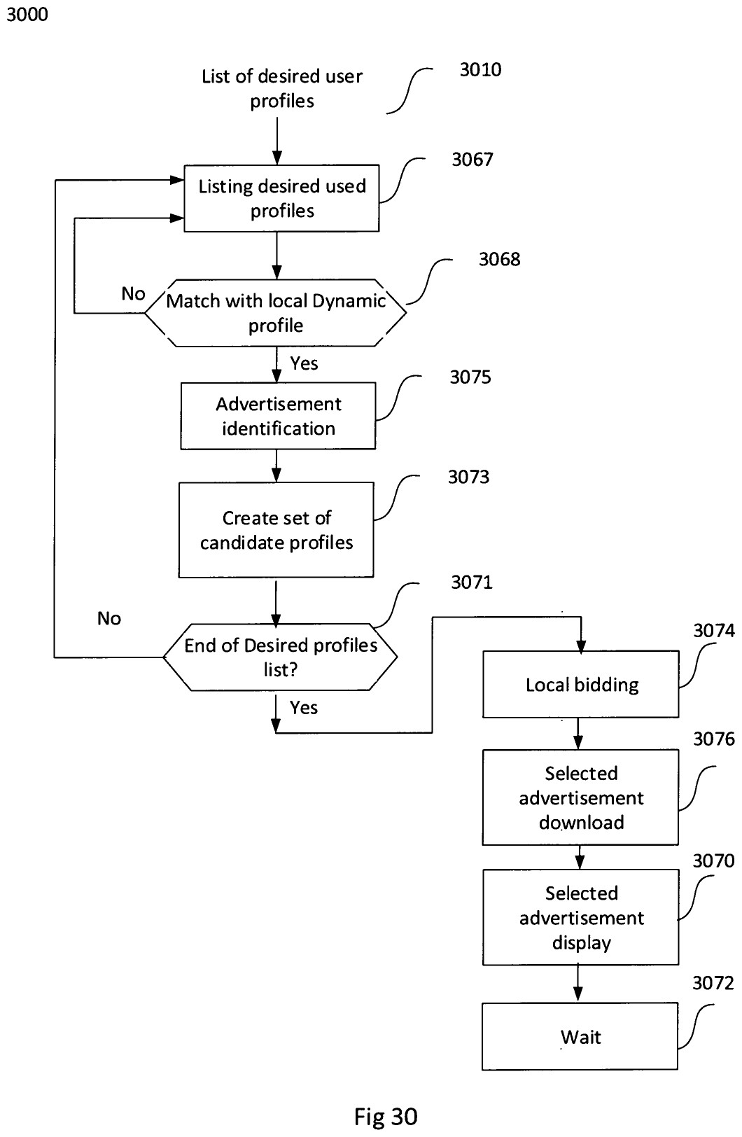

Figures FIG. 27, FIG. 28, FIG. 29 and FIG. 30 present the local advertisement selecting. In the case of FIG. 27 and FIG. 28 all proposed advertisements and List of desired user profiles are downloaded simultaneously. The algorithm on FIG. 27 in the first step 2767 lists desired user profiles proposed by advertisers one by one. If some profile matches the local Dynamic user profile 2768 the corresponding advertisement is identified 2769 and displayed 2770 immediately. In this variant no bidding is done. If there are more profiles to check 2771 the entire process repeats. If no more profiles are there and no corresponding advertisements, the process goes in state of waiting 2772 for new set of profiles and advertisements.

On the flowchart FIG. 28 the advertisements and the List of desired profiles are downloaded simultaneously too, but the Advertisements are not displayed immediately. Instead, a set of candidate consumer profiles and advertisements is created 2873. Set of candidate profiles means that those arrived Desired consumer profiles match the local Dynamic consumer profile, but for final selection the ones with the best financial offer have to be selected. After checked 2871 the entire List of desired profiles, the Local bidding procedure 2874 is made, which thus determines the one or more advertisements to display. Bidding 2874 is conducted according to the proposed price and additional data (all extracted from Desired profile 720). Eventually the process goes in state of waiting 2872 for new set of profiles and advertisements.

In the case shown in FIG. 29 advertisements are not downloaded simultaneously with list of advertisements and accompanied desired profiles. So, in the first step only the List of desired profiles 2910 is downloaded, then listed 2967 for every single Desired consumer profile and checked 2968 on matching with local Dynamic consumer profile. After the right advertisement is selected 2975 it is downloaded 2976 and displayed 2970 immediately. When procedure reached the end of the List of desired profiles in step 2971 it goes in waiting state 2972 for new set of profiles and advertisements. Otherwise it goes to the first step again and keeps listing 2967.

The flowchart on FIG. 30 the advertisements and the List of desired profiles are downloaded separately too, but then a set of candidate profiles is created 3073. Set of candidate profiles means that those arrived Desired consumer profiles match (3068) the local Dynamic consumer profile, but for final selection the ones with the best financial offer have to be selected. After the entire List of desired profiles is completely passed 3071 the Local bidding 3074 is done which thus determines the one or more advertisements to display. Bidding 3074 is conducted according to the proposed price and additional data (extracted from Desired profile 720). After the Local bidding 3074 the selected advertisements are downloaded 3076 and displayed 3070. At the end, the process goes in state of waiting 3072 for new set of profiles and advertisements.

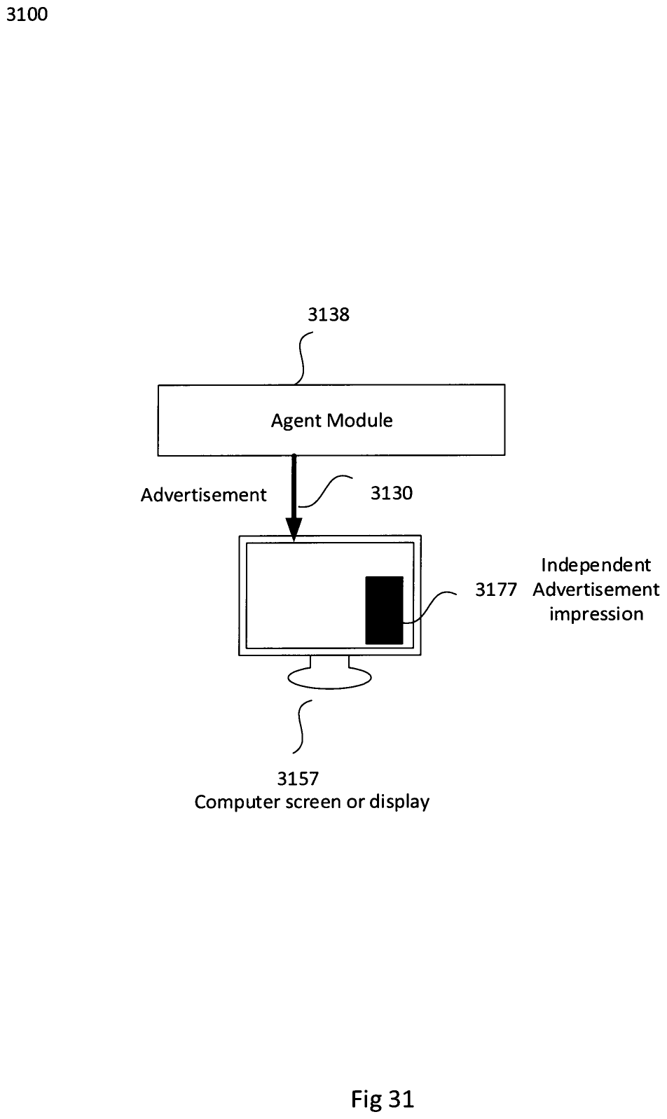

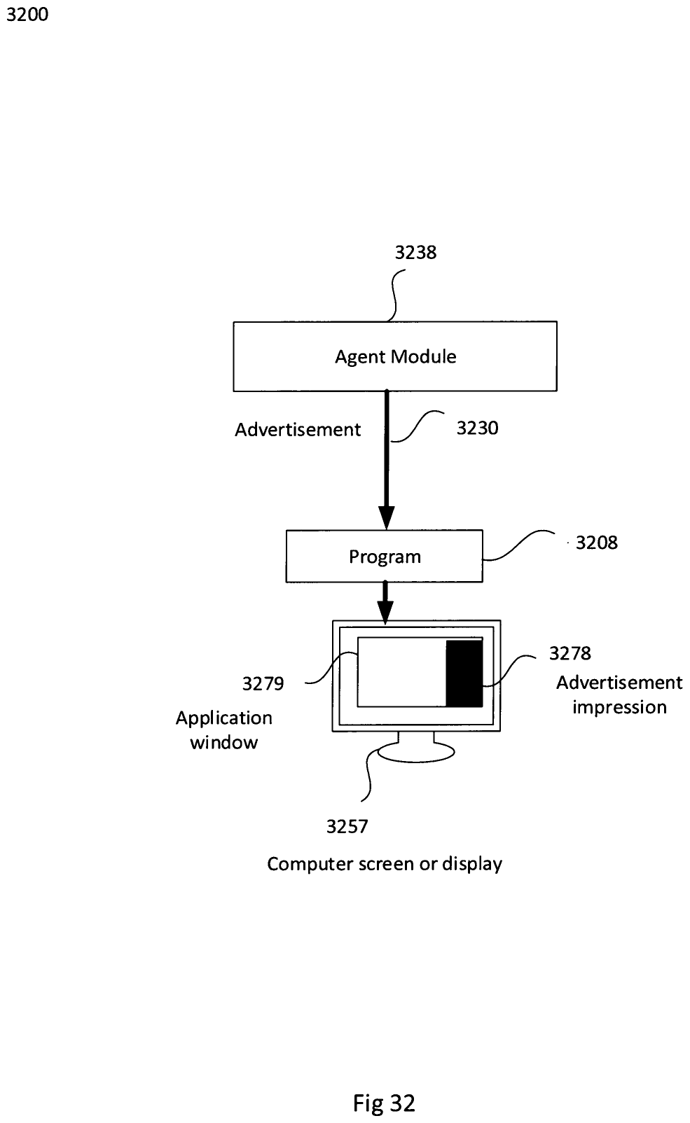

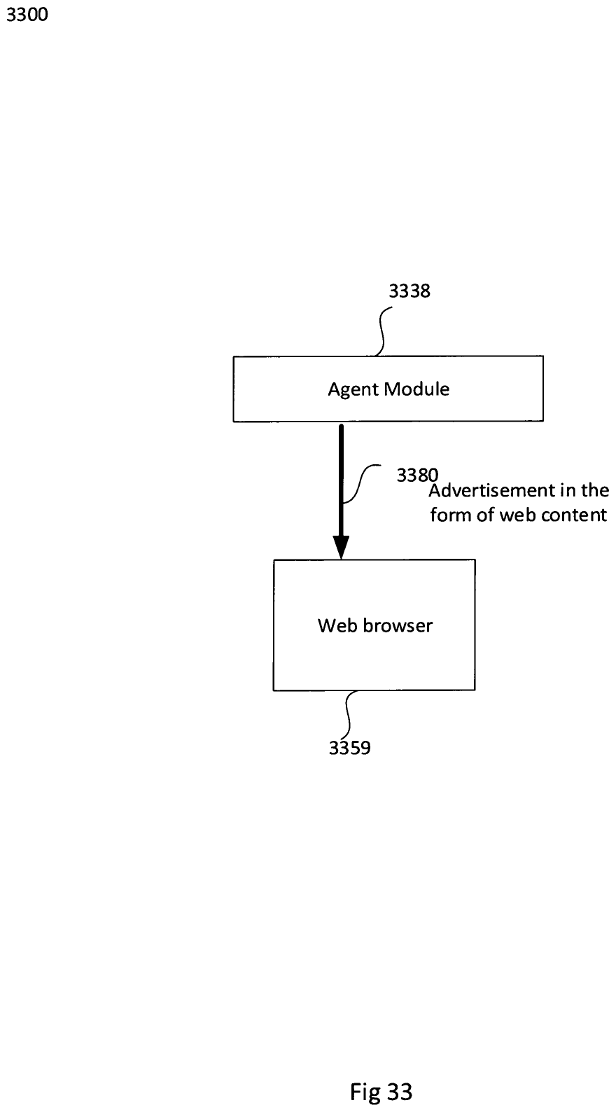

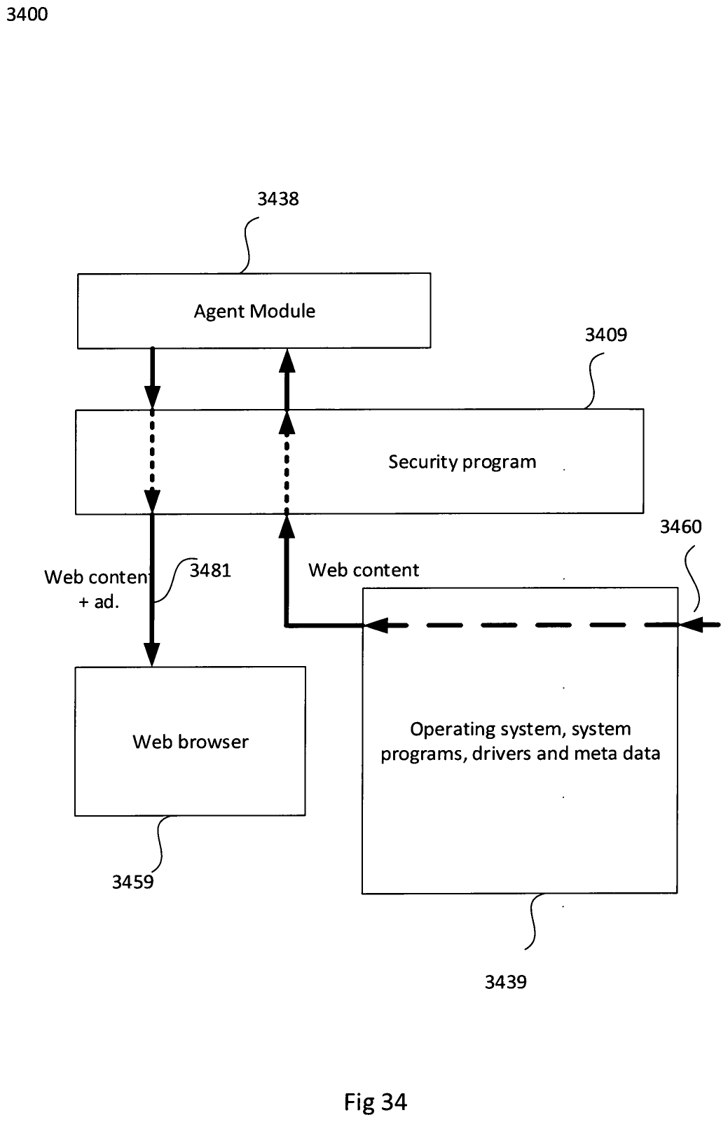

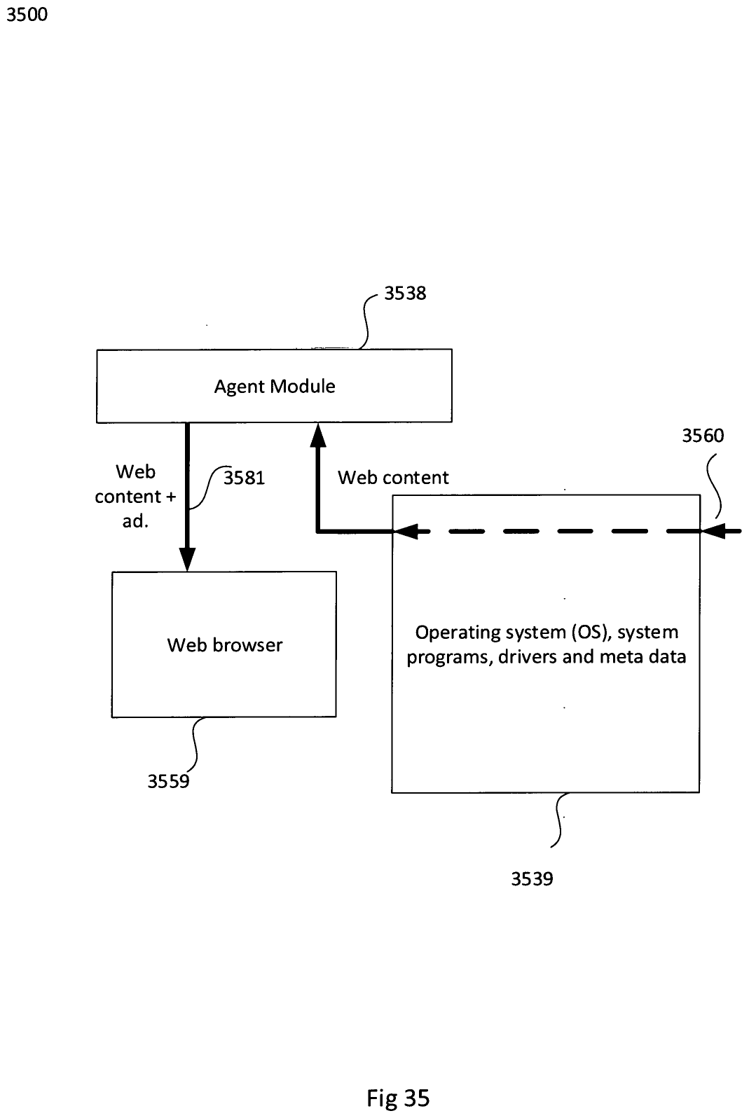

Downloaded advertisements are first stored in the Agent Module's database, and so prepared wait for displaying on the user's computer monitor or the smart portable device. The advertising content displaying can be done in several ways: direct independent impression (FIG. 31), impression by another application (FIG. 32) or inserted into web content and displayed on the appropriate web browser (FIG. 33, FIG. 34 and FIG. 35). The instructions how to display advertisement are contained in Displaying instructions 729 field of Desired consumer profile 720 (FIG. 7).

When Advertisements 3130 are displayed directly (FIG. 31) the Agent Module 3138 opens the independent graphic windows 3177 on the screen or display 3157 and presents the advertising content. These impressions are displayed independently of the other programs, sometimes partly covering their graphical windows on the screen (pop-up windows), or opening like pop-under window. The Agent Module 3138 therefore has ability to directly display text, graphics, animated, audio or video contents on the screen. In a case of direct displaying, the advertisement will be inevitably presented to the user, no matter of website the user is currently visiting or applications using.

Displaying the Advertisements 3230 through another program (FIG. 32) means that there is an application program 3208 which already has graphical interface adjusted for displaying external graphical content. In this case displaying is done by the Agent Module 3238 which sends advertising content 3230 to the application 3208 which then displays it, using its own functionality and its own graphic interface. Both Agent Module 3238 and Application 3208 have the appropriate programming interfaces for communication and content exchange. The Application 3208 can be Security program too, since they very often have implemented features to display graphical content, so if Agent Module 3238 is attached to Security program for self-profiling, the Security program can be used to display advertisements too.

Displaying advertisements in web browser means that the Advertisements are presented in the form of web content. It is important to stress that such a web content is finally created or assembled locally in the local consumer computer, by the Agent Module.

In the simplest way, the impression can be formed so that the entire web page displayed in the local web browser 3359 contains only advertisement (FIG. 33). No externally received web content is used, only locally selected Advertisement which won the competition during the Bidding procedure (2874 or 3074). This variant can be best used in situations when web browser is just started or during short pause while new web page is waited to be downloaded.

The other options are based on some modification of incoming web content, before it is forwarded to web browser 3459. In such cases a web browser displays the original web content, locally mixed with advertisement content. After coming in the computer, the original web content 3460 is intercepted by Security program 3409 (FIG. 34) and sent to the Agent Module 3438 for check if it's possible to modify its content by advertisement. Modifying web content 3481 can be done either as partial replacement of the genuine web content by Advertisement or just insertion of a new Advertisement into the source web content. Such modified web content with inserted advertisement 3481, the Agent Module 3438 sends to the web browser 3459, where selected web page with added advertisement is eventually displayed. The user does not have to be aware that the original web page has been changed in any way.

There is another possible option. After coming in the computer, the original web content 3560 is intercepted by operating system 3539 (FIG. 35) and sent to the Agent Module 3538 for check if it's possible to modify its content by Advertisement. Modifying web content 3581 can be done either as partial replacement of the genuine web content by advertisement or just insertion of a new advertisement into the source web content. Such modified web content with inserted advertisement, the Agent Module 3538 sends to the web browser 3559 where selected web page with added advertisement 3581 is eventually displayed. The user does not have to be aware that the original web page has been changed in any way.

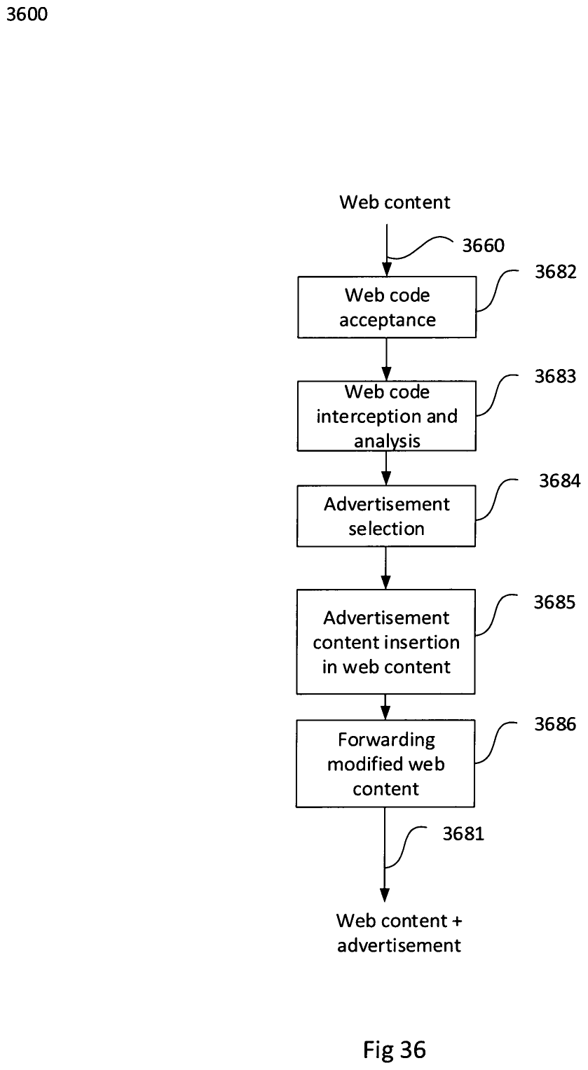

Web content modification can be done in two ways: by forced insertion of advertising content or by insertion based on an appropriate pre-defined tag in the web code. With forced insertion (FIG. 36) the advertising content is just inserted, simply by modifying the web page source content 3660. After receiving 3682 the web content code, its analysis 3683 is performed and the most suitable place in the web page for inserting advertising content selected. The Advertisement selection 3684 in this case can be done by Local bidding in real time, so that the final decision which advertisement to display can be made according to some characteristics of the downloaded web page (form instance domain, keywords etc.). After the most appropriate advertisement is selected 3684, its advertising code or tag with link 3685 is inserted directly into the original web code 3660 and such modified content 3681 forwarded 3686 to the web browser.

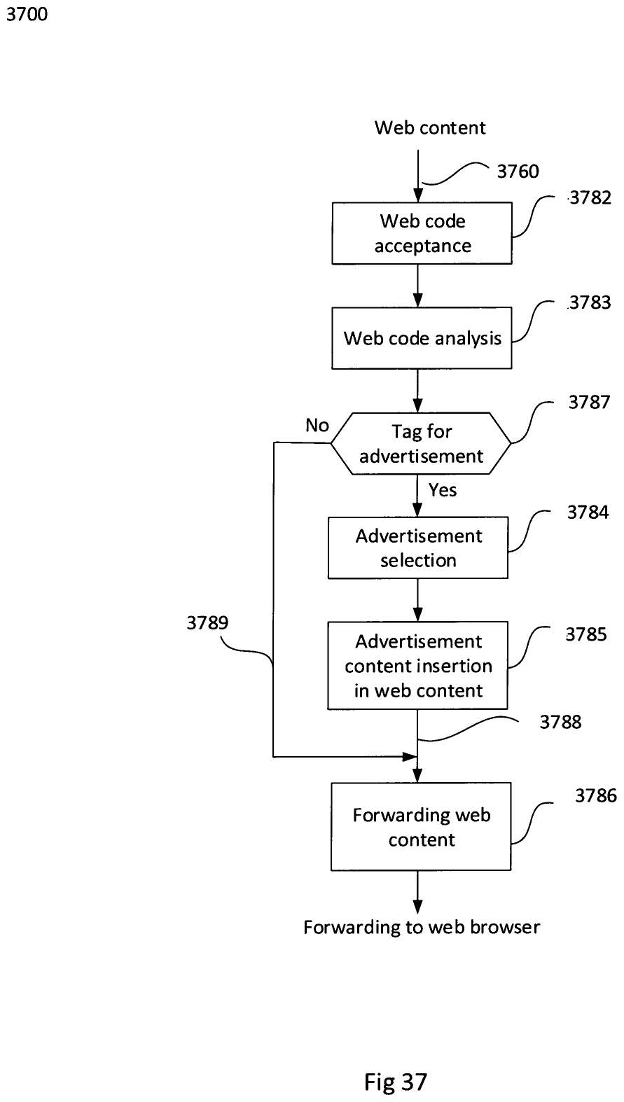

The insertion of advertising content based on the appropriate tag in the genuine website code (FIG. 37) is carried out only in situations when there is a special tag contained in original web page code 3760. This means that the advertisements and related information about displaying are allowed to be inserted. After intercepting web content 3782, the Agent Module analyzes its code 3783 and checks 3787 for the special tag. If tag does not exist, unmodified web content 3789 is forwarded to the web browser. In this case, nothing is inserted nor modified in the source code of the website, which means that the contents 3760 and 3789 are identical. However, if the tag exists, the selection of the advertisement is done 3784 and inserted into the web content 3785, and then such modified web content with the advertisement 3788 presented on the display 3786. The user does not know if the advertising content has been inserted locally in the computer.

What is claimed is:

1. A Self-profiling method for use of security programs or operating systems in digital marketing, wherein the function of advertisement selection is placed in the local computer, such that local consumer computer equipped by Agent Module, which is attached to security program or operating system, collects and analyzes all user-related information relevant for marketing and targeting, in order to make Dynamic consumer profile of local user, and after comparation of the Dynamic consumer profile against Desired consumer profiles from the List of desired consumer profiles, created by remote Advertisers and received from remote servers, and after local price bidding process, identifies the most appropriate advertisements from proposed set to download and display to the local user.

2. A method of claim 1, wherein Dynamic consumer profile, containing marketing-relevant information about individual local consumer and placed in local file or database, never leaves local consumer computer, thus protecting consumer privacy.

3. A method of claim 1, wherein both Dynamic consumer profile and Desired consumer profile, are structures of data relevant for marketing and targeting in advertising, with the following correspondent fields:
Psychographic data from Dynamic consumer profile correspond in data type and structure to Desired psychographic data from Desired consumer profile;
Demographic data from Dynamic consumer profile correspond in data type and structure to Desired demographic data from Desired consumer profile;
Geographic location data from Dynamic consumer profile correspond in data type and structure to Desired geographic location data from Desired consumer profile;
Behavioral data from Dynamic consumer profile correspond in data type and structure to Desired behavioral data from Desired consumer profile;
Data about Personal interests from Dynamic consumer profile correspond in data type and structure to data about Desired personal interests from Desired consumer profile;
Miscellaneous personal data from Dynamic consumer profile correspond in data type and structure to Miscellaneous desired personal data from Desired consumer profile;
History of behavior on the Internet from Dynamic consumer profile correspond in data type and structure to Desired history of behavior on the Internet from Desired consumer profile;
while Offered price and other data necessary for bidding, and Displaying instructions, which defines the mode of advertisement displaying, exist only in Desired consumer profile, but not in Dynamic consumer profile data structure.

4. A Self-profiling system for use of Security programs or operating systems in digital marketing, comprising:
Advertising server, a software installed on remote location, comprising:
Front-end user interface, used by Advertisers to upload advertisements to Advertising server, set Desired consumer profiles and read reports;
Back-end functions, used for assembling List of desired consumer profiles from individual Desired consumer profiles received from Front-end user interface, delivering the List of desired consumer profiles to consumer Agent modules, storing base of advertisement data and advertisements, billing system and system management;
Agent Module, a software attached to Security program or operating system of the local consumer computers, comprising:
Self-profiling function, comprising:
Function Analyzing intercepted data, which analyzes data received from external sources, such as Internet, and from user activities on the local computer, in order to identify user behavior, personality traits, habits, visited web sites and activities, which are all necessary inputs for Dynamic consumer profile maintenance function;
Function Dynamic consumer profile maintenance, which means creation and regular updating of the Dynamic consumer profile of local user;
Function Receiving intercepted data, which retrieves incoming web traffic or local user actions on computer, intercepted by Security program or operating system, and deliver copies of intercepted data to Agent Module's Self-profiling function for analyzing;
Desired profiles list download function, which retrieves a List of desired consumer profiles, sent from Advertising server;
Profiles comparation function, which compares local Dynamic consumer profile against every single Desired consumer profile from the List of desired consumer profiles, resulting either an identified profile for immediate advertisement displaying, or a set of candidate profiles, which are forwarded to Local bidding function;
Local bidding function, which uses data from Offered price and other data necessary for bidding field of Desired consumers profile from the set of candidate profiles and according the offered prices for display of advertisement associated with each profile from the set of candidate Desired consumer profiles, identifies the most appropriate ones to display to the local user;
Advertisement download function, which receives advertisements either directly from Advertising servers, indirectly from Security program or indirectly from operating system, while download can be done either simultaneously with List of desired profiles download or separately;
Function Advertisement display to the local user, uses Displaying instruction from Desired consumer profile to identify how Advertisers want their advertisement to be displayed, either immediately after profiles comparation and advertisement download, or after bidding and advertisement download, in one of three ways:
using independent graphical windows on the computer screen or display opened by Agent Module itself;
using graphical function of Security program or some other applications capable to display advertising content;
using insertion into intercepted web content before the content is delivered to web browser;
personal consumer computers and smart mobile devices connected to the Internet;
consumer client software, which can be Security program, operating system or some other application installed on personal computers or smart mobile devices, with capabilities to intercept incoming and outgoing data traffic, user actions on local personal computers and other smart devices where the software is installed, as well as capabilities for displaying advertisement on computer or smart mobile device screen or display.

5. A system of claim 4, wherein advertisement displaying using insertion into web content intercepted by Security program or operating system and forwarded to the Agent Module before delivering to the web browser, can be done in two ways:
as forced insertion, which means that Agent Module decides whether and where to insert advertisement into intercepted original web content;
as a local Agent Module's advertisement insertion according to special tag, written in advance in original incoming web content, which pre-defines the impression location and other displaying characteristics, while Agent Module just makes the Advertisement selection and insert advertisement according to tag instructions.

6. A system of claim 4, wherein the function Analyzing intercepted data:
retrieves web content data intercepted by Security program;
retrieves web content data intercepted by operating system
retrieves data about local user actions on local computer, intercepted by Security program;
retrieves data about local user actions on local computer, intercepted by operating system;
analyzes and processes retrieved data and prepares information for the function Dynamic consumer profile maintenance.

7. A system of claim 4, wherein function Dynamic consumer profile maintenance initially has no Dynamic consumer profile, which is created by Questionnaire about consumer's personality traits and interests, that is filled by consumer;
After initial Dynamic consumer profile filling the function Dynamic consumer profile maintenance regularly retrieves processed information from the function Analyzing intercepted data and updates or modifies the Dynamic consumer profile.
